(19) United States
(12) Patent Application Publication
(10) Pub. No.: US 2023/0251913 A1
(43) Pub. Date: Aug. 10, 2023

(54) ANALYSIS SUPPORT METHOD AND INFORMATION PROCESSING APPARATUS

(71) Applicant: Fujitsu Limited, Kawasaki-shi (JP)

(72) Inventors: Saeko Nakamura, Ichinomiya (JP); Koki Ariga, Nagakute (JP); Takeshi Kawaguchi, Nagoya (JP)

(73) Assignee: Fujitsu Limited, Kawasaki-shi (JP)

(21) Appl. No.: 17/979,598

(22) Filed: Nov. 2, 2022

(30) Foreign Application Priority Data
Feb. 4, 2022 (JP) 2022-016508

(51) Int. Cl. G06F 9/50

(52) U.S. Cl. CPC G06F 9/5083; G06F 9/5038; H04L 67/10

(57) ABSTRACT

A non-transitory computer-readable recording medium stores a program for causing a computer to execute a process, the process includes identifying a change order of resources which are used by processes involved in a first function of a system constructed by using sharable resources and which change in accordance with an execution order of the processes, and for a specific time targeted for a performance analysis of the system, outputting information with which first performance items among second performance items concerning the resources used by the processes involved in the first function are identifiable in accordance with the identified change order, wherein each of actually measured values of the first performance items at the specific time is an outlier of a correlation with a response of the first function.

### CROSS-REFERENCE TO RELATED APPLICATION

This application is based upon and claims the benefit of priority of the prior Japanese Patent Application No. 2022-16508, filed on Feb. 4, 2022, the entire contents of which are incorporated herein by reference.

### FIELD

An embodiment discussed herein is related to an analysis support method and an information processing apparatus.

### BACKGROUND

In recent years, shift to public clouds for business systems have been advanced as an effort for cost reduction and digital transformation (DX). In the public clouds, a user uses resources on a cloud by sharing the resources with many and unspecified other users.

As the related art, for example, there is a technique for selecting performance information of an infrastructure to be used for monitoring performance information of an application. There is another technique for extracting a type of performance information of a virtual machine that causes a processing delay of an application based on the confidence and support calculated based on performance information of the application converted into binary data based on a first threshold and performance information of the virtual machine converted into binary data based on each of second thresholds. There is another technique for identifying a root cause probability for each of correlated objects, and outputting an identification of a root object causing an anomaly based on the identified root cause probability.

Japanese Laid-open Patent Publication No. 2017-078963, Japanese Laid-open Patent Publication No. 2017-146727, and Japanese National Publication of International Patent Application No. 2018-530803 are disclosed as related art.

### SUMMARY

According to an aspect of the embodiment, a non-transitory computer-readable recording medium stores a program for causing a computer to execute a process, the process includes identifying a change order of resources which are used by processes involved in a first function of a system constructed by using sharable resources and which change in accordance with an execution order of the processes, and for a specific time targeted for a performance analysis of the system, outputting information with which first performance items among second performance items concerning the resources used by the processes involved in the first function are identifiable in accordance with the identified change order, wherein each of actually measured values of the first performance items at the specific time is an outlier of a correlation with a response of the first function.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of an analysis support method according to an embodiment;

FIG. 2 is a diagram illustrating a system configuration example of an analysis support system;

FIG. 3 is a block diagram illustrating a hardware configuration example of an analysis support apparatus;

FIG. 4 is a diagram illustrating an example of information stored in a data table;

FIG. 5 is a diagram illustrating an example of information stored in an outlier table;

FIG. 6 is a diagram illustrating an example of information stored in a change order table;

FIG. 7 is a diagram illustrating an example of information stored in a correlation table;

FIG. 8 is a diagram illustrating a transition example of various screens;

FIG. 9 is a block diagram illustrating a functional configuration example of the analysis support apparatus;

FIG. 10 is a diagram illustrating a screen example of a top screen;

FIG. 11A is a diagram illustrating an example of a response analysis screen (part 1);

FIG. 11B is a diagram illustrating the example of the response analysis screen (part 2);

FIG. 11C is a diagram illustrating the example of the response analysis screen (part 3);

FIG. 11D is a diagram illustrating the example of the response analysis screen (part 4);

FIG. 12A is a diagram illustrating an example of a cloud infrastructure influence check screen (part 1);

FIG. 12B is a diagram illustrating the example of the cloud infrastructure influence check screen (part 2);

FIG. 13 is a diagram illustrating a screen example of a cloud infrastructure influence tendency check screen;

FIG. 14 is a flowchart illustrating an example of a correlation calculation processing procedure of the analysis support apparatus;

FIG. 15 is a flowchart illustrating an example of a change order identification processing procedure of the analysis support apparatus;

FIG. 16 is a flowchart illustrating an example of an outlier calculation processing procedure of the analysis support apparatus;

FIG. 17 is a flowchart illustrating an example of a first output control processing procedure of the analysis support apparatus;

FIG. 18 is a flowchart illustrating an example of a second output control processing procedure of the analysis support apparatus; and

FIG. 19 is a flowchart illustrating an example of a third output control processing procedure of the analysis support apparatus.

### DESCRIPTION OF EMBODIMENT

In the related art, in a case where a problem such as a response degradation occurs, it is difficult to determine an influence of a cloud infrastructure on a system.

Hereinafter, with reference to the drawings, an embodiment of an analysis support method and an information processing apparatus according to the present disclosure will be described in detail.

### Embodiment

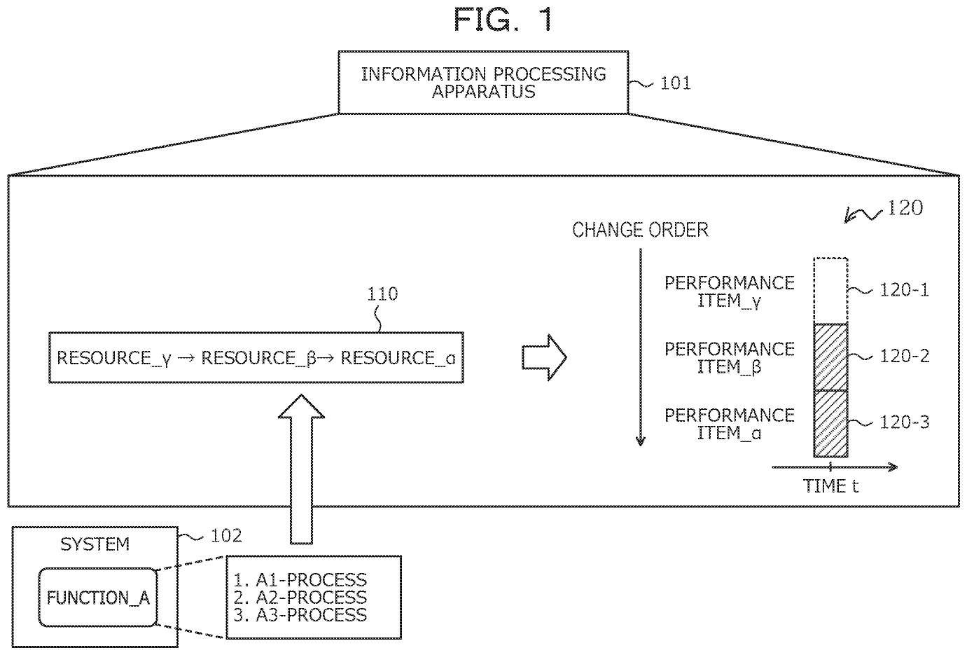

FIG. 1 is a diagram illustrating an example of an analysis support method according to the embodiment. In FIG. 1, an information processing apparatus 101 is a computer that supports a performance analysis of a system constructed by using sharable resources. Examples of the sharable resources include a central processing unit (CPU), a memory, a network, an auxiliary storage device, and the like. For example, the system is a business system.

As a system constructed by using sharable resources, for example, there is a system implemented by a public cloud. For example, many and unspecified users share and use resources in the public cloud. The public cloud makes it possible to easily start a system with small start, and flexibly change a system configuration in accordance with a situation such as an increase or decrease in the access count.

On the other hand, in the case of using the public cloud, even when an own system does not particularly change, the performance of the own system may degrade due to some influence of the cloud side. For example, it is assumed that a user A uses an operation section X to construct a business system and a user B starts using the same operation section X at a certain time.

In this case, use of a large amount of resources in a system constructed by the user B may disable the system of the user A from using the resources initially used, which may cause a response delay in the system of the user A. As described above, even though there is no problem in the responses at the start of the operation, response delays may occur since the certain time.

When a problem such as a response degradation occurs, a cloud user distinguishes whether the problem is due to a problem of the cloud side or a problem of the own system. However, in the related art, the cloud user has no way to obtain information on the cloud side and consumes time to isolate the problem.

For example, since the performance on the entire cloud infrastructure is within a management range of an administrator of the cloud infrastructure, the cloud user side is not allowed to refer to the performance. Since information with which a problem on the cloud infrastructure side is recognizable may contain information on other users, the cloud user is prohibited from referring to the information in many cases from the viewpoint of confidentiality of the information.

Generally, a problem related to performance of a server is not included in a service level agreement (SLA) in many cases. For this reason, in an operation management task in the related art, a business system administrator has to conduct an investigation by himself or herself by fully using available information (only within the range of the own system) when there is no problem in the SLA.

However, in the operation management task in the related art, a person who does not know that the own system may be affected depending on a situation of the entire cloud infrastructure may not even infer a cause of the problem. Even a person who knows that the own system may be affected has no way to detect the resource tightness on the cloud infrastructure side and therefore has to comprehensively determine a cause of the problem based on his/her operational experience. Those who have little operational experience have difficulty in determining a cause of the problem.

In the case of an on-premises physical environment, resources within the company are used, and the business system administrator is allowed to access and investigate all the information on the business system. Accordingly, when a problem such as a response degradation occurs, a situation in which a cloud user has no way to obtain information on the cloud side and consumes time to isolate the problem as described above is unlikely to occur. In the cases of both of on-premises type and hosting type of private clouds, only limited users use their dedicated operation sections. For this reason, the business system administrator is allowed to perform the investigation for a response degradation by acquiring and investigating the information within the used range, and by collaborating the infrastructure administrator.

However, since the shift to public clouds for business systems have been advanced in recent years, it is important that a user himself or herself distinguishes which occurs, an influence of the cloud infrastructure or a problem of the own system. For this reason, there is a demand for a mechanism in a case of using an operation section shared by many and unspecified users like a public cloud, the mechanism enabling a cloud user to detect a performance degradation due to an influence of a cloud infrastructure and cope with the degradation at an early stage.

Accordingly, in the present embodiment, description will be given of an analysis support method that enables determination of a performance item affected by a cloud infrastructure among performance items concerning resources used by processes involved in a function of a system. Processing examples (equivalent to the following processing (1) and (2)) of the information processing apparatus 101 will be described.

(1) The information processing apparatus 101 identifies a change order of resources used by processes involved in each function of a system 102. The resources change in accordance with an execution order of the processes. The system 102 is a system constructed by using sharable resources, and is, for example, a business system implemented by a public cloud. In the public cloud, many and unspecified users share an operation section by sharing the resources.

The functions of the system 102 are information processing provided by the system 102, and examples thereof include data aggregation, data reference, data registration, and the like. The functions of the system 102 use different types of resources. Examples of the resources include a CPU, memory, a network, a disk (auxiliary storage device), and the like.

For example, in the case of the function “data aggregation”, processes are executed in the order of “data reading process→data processing process→data writing process”. For example, the data reading process uses the memory and the disk. For example, the data processing process uses the CPU and the memory. For example, the data writing process uses the CPU and the disk.

In the case of the function “data reference”, for example, processes are executed in the order of “request receiving process→data reading process→data processing process→returning process”. For example, the request receiving process uses the network. For example, the data reading process uses the memory and the disk. For example, the data processing process uses the CPU and the memory. For example, the returning process uses the network.

In the case of the function “data registration”, for example, processes are executed in the order of “request receiving process→data processing process→data writing process→returning process”. For example, the request receiving process uses the network. For example, the data processing process uses the CPU and the memory. For example, the data writing process uses the CPU and the disk. For example, the returning process uses the network.

As described above, the types of resources used by processes vary depending on which processes are involved in each of the functions of the system 102. For this reason, the change order of the resources used by the processes involved in each of the functions of the system 102 varies depending on the execution order of the processes involved in the function of the system 102.

For example, the information processing apparatus 101 may execute processes involved in each of the functions of the system 102 to identify the order of the resources used by the processes. The information processing apparatus 101 may identify the change order of the resources used by the processes involved in the function of the system 102 by referring to the identified order of the resources used by the processes.

An example in FIG. 1 will be described by using, as an example, a case where a function of the system 102 is “function_A”, and “resource_γ→resource_β→resource_α” is identified as a change order 110 of resources used by processes (A1-process→A2-process→A3-process) involved in function_A.

There is a case where the processes involved in the function of the system 102 use the same type of resource two or more times. In this case, when identifying the change order of the resources, the information processing apparatus 101 may omit the same type of resource in the second and subsequent uses.

(2) Regarding a time t, the information processing apparatus 101 outputs information with which a performance item whose actually measured value at the time t is an outlier of a correlation with a response of the function among performance items concerning the resources used by the processes involved in the function of the system 102 is identifiable in accordance with the identified change order of the resources. The time t is any time targeted for a performance analysis of the system 102. The information with which a performance item having the outlier is identifiable may be expressed by, for example, a sentence or a chart.

The performance items concerning the resources are information on the resources exerting the performance of a system (for example, the system 102). Examples of the performance items include a CPU usage rate, a memory usage rate, a free memory capacity, a disk input/output (I/O) count, a disk throughput, a network packet count, a network throughput, and the like.

The outlier of the correlation with the response of the function is a value (a value of a performance item) deviating from the correlation between the response of the function and the performance item. The response of the function is expressed as a time period from when a request for the function is issued to when a response is returned. The actually measured value at the time t is a measured value of the performance item, and indicates the value of the performance item at the time t.

The response of the system has a correlation with a resource usage amount of the system. For example, in the case of a system in which the processing amount of the CPU increases along with an increase in the access count, the usage amount of CPU resources increases along with the increase in the access count. For this reason, when the access count is too large, a shortage of the CPU resources causes processing waiting and degrades the response. In this case, the response appears to have correlations with the access count and the CPU usage rate.

Since the resources are shared by many and unspecified users who use the same operation section in the public cloud, the resource usage amount of the entire cloud infrastructure increases or decreases depending on the usage states of the other users. For example, it is assumed that users A and B use an operation section X and a user C also uses the operation section X from halfway. In this case, if the user C uses a large amount of resources, the resource usage amount in the operation section X increases.

In the public cloud, when the resource usage state of the entire cloud infrastructure is tightened, there is a case that the user side may not use sufficient resources in some cases. For example, in a case where the CPU usage rate in the operation section X is 100%, even if the system of the user A requests the CPU, there is no allocable CPU. For this reason, the system of the user A may not sufficiently use the CPU and faces the occurrence of a phenomenon in which the response is degraded despite the low CPU usage rate.

As described above, in a normal state, there is a correlation in which the CPU usage rate is high as the response is degraded. However, due to an influence of the cloud infrastructure, a phenomenon may occur in which the response is degraded even though the CPU usage rate is low. The normal state refers to a state in which there is room in the resource usage state of the entire cloud infrastructure.

Accordingly, in order to determine whether or not the performance of the own system is affected by an influence of the cloud infrastructure, it is possible to use information indicating whether or not there is a deviation from the correlation between the response and the performance item in the normal state (an outlier of the correlation). For example, when the function “data aggregation” is not allowed to use the memory sufficiently due to an influence of the cloud infrastructure in the data reading process, the response of the function “data aggregation” is degraded.

In this case, even when the CPU and the disk are not affected by the cloud infrastructure, the correlations of the response with the CPU and the disk are different from those in the normal state. For this reason, in order to determine an influence of the cloud infrastructure, it is important to enable a performance item that first deviates from the correlation to be recognized among the performance items concerning the resources used by the processes involved in the function.

In the example in FIG. 1, the resources used by the processes involved in function_A in the system 102 are resource_α, resource_β, and resource_γ. A performance item concerning resource_α is referred to as “performance item_α”, a performance item concerning resource_β is referred to as “performance item_β”, and a performance item concerning resource_γ is referred to as “performance item_γ”. Among performance item_α, performance item_β, and performance item_γ, “performance item_α and performance item_β” are assumed to be performance items whose actually measured values at the time t are outliers of the correlations with the response of function_A.

In this case, for example, the information processing apparatus 101 outputs a graph 120 regarding the time t. In the graph 120, performance item_α and performance item_β whose actually measured values at the time t are the outliers of the correlations with the response of function_A are presented in accordance with the identified change order 110 such that an order relationship between the performance items is identifiable. The graph 120 is an example of the information with which the performance items having the outliers are identifiable. The graph 120 includes cells 120-1 to 120-3. The cell 120-1 represents performance item_γ. The cell 120-2 represents performance item_β. The cell 120-3 represents performance item_α. The cells 120-1 to 120-3 indicate the change order of performance item_γ, performance item_β, and performance item_α.

As described above, in analyzing a cause for a response delay of function_A of the system 102, the information processing apparatus 101 enables a performance item affected by the cloud infrastructure to be determined among the performance items concerning the resources used by the processes involved in function_A.

For example, by referring to the graph 120, the user knows that the performance item that deviates first from the correlation with the response of function_A is performance item_β. Accordingly, the user may determine that performance item_β is affected by the cloud infrastructure. The user also may determine that performance item_α deviated due to the deviation of performance item_β. As a result, for example, the user may perform detailed investigation or the like by inferring that there is a possibility of a response delay occurring due to the unavailability of resource_β.

(System Configuration Example of Analysis Support System 200)

Next, a system configuration example of an analysis support system 200 including the information processing apparatus 101 illustrated in FIG. 1 will be described. The description will be given by taking, as an example, a case where the information processing apparatus 101 illustrated in FIG. 1 is applied to an analysis support apparatus 201 in the analysis support system 200.

The following description will be given by taking as an example a system implemented by a public cloud as a system constructed by using sharable resources. However, the present analysis support method is not limited to the public cloud, but may be used, for example, in a case where a user side desires to investigate a problem on a resource providing side in a system in which resources are shared by multiple users.

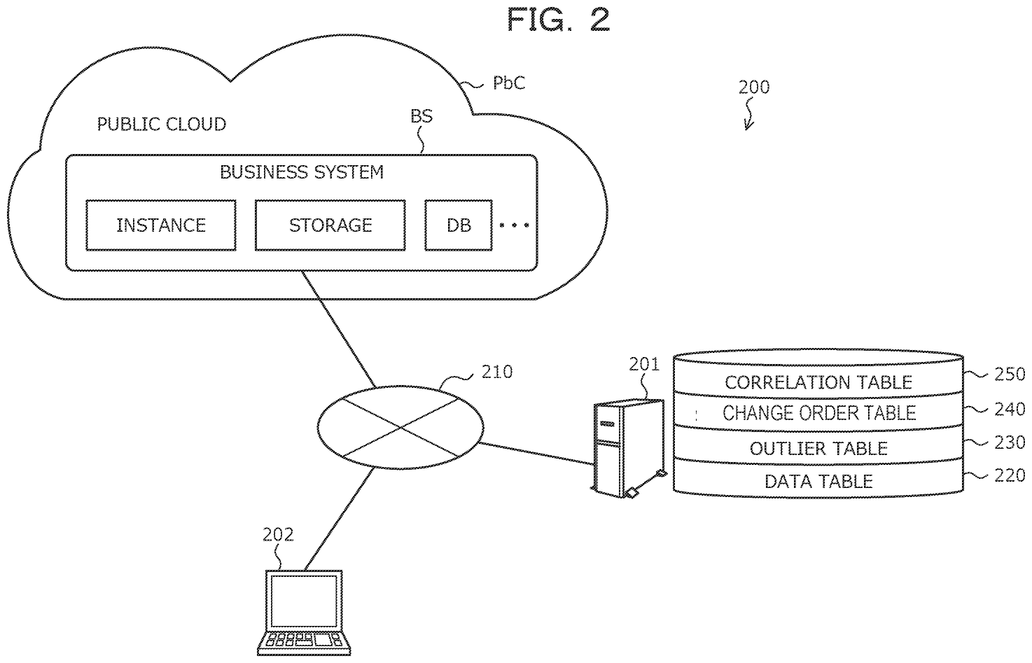

FIG. 2 is a diagram illustrating a system configuration example of the analysis support system 200. In FIG. 2, the analysis support system 200 includes an analysis support apparatus 201, a client apparatus 202, and a business system BS. In the analysis support system 200, the analysis support apparatus 201, the client apparatus 202, and the business system BS are coupled to each other via a wired or wireless network 210. The network 210 is, for example, the Internet, a local area network (LAN), a wide area network (WAN), or the like.

The analysis support apparatus 201 is a computer that supports a performance analysis of the business system BS. The business system BS is a system on a cloud infrastructure founded by a public cloud PbC. For example, the business system BS provides various services, such as an instance (virtual machine), a storage, and a database (DB).

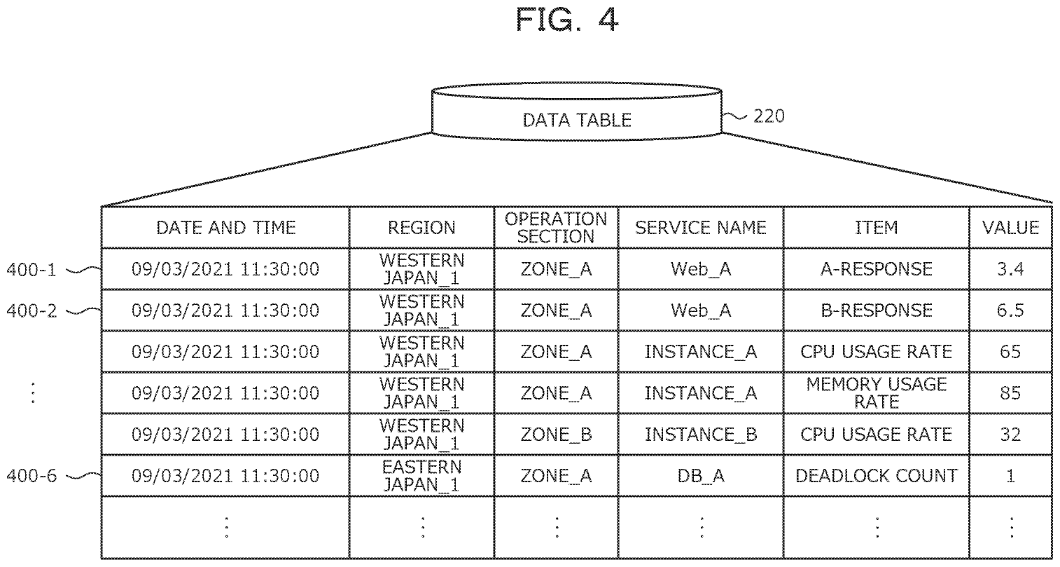

The analysis support apparatus 201 includes a data table 220, an outlier table 230, a change order table 240, and a correlation table 250. Information stored in these tables 220, 230, 240, and 250 will be described later with reference to FIGS. 4 to 7. For example, the analysis support apparatus 201 is a server.

The public cloud PbC is a service that provides a cloud computing environment such as servers, storages, and databases to many and unspecified users through the network 210. The users are, for example, companies and individuals. Multiple users may share the resources in the public cloud PbC. The public cloud PbC is implemented by, for example, a server group.

The client apparatus 202 is a computer used by a user. The user is, for example, an administrator of the business system BS. For example, in the client apparatus 202, the administrator uses a data visualization tool such as a dashboard to monitor and analyze the performance of the business system BS. The client apparatus 202 is, for example, a personal computer (PC), a tablet PC, or the like.

Although only the business system BS is illustrated as a system constructed on the cloud infrastructure in the example of FIG. 2, the system is not limited to this. For example, business systems of many and unspecified users, which are implemented by the public cloud PbC, are included on the cloud infrastructure. Although only one client apparatus 202 is illustrated, the analysis support system 200 includes, for example, client apparatuses 202 used by the administrators of the respective business systems. Although the analysis support apparatus 201 and the client apparatus 202 are separately provided, the present disclosure is not limited thereto. For example, the analysis support apparatus 201 may be implemented by the client apparatus 202.

(Hardware Configuration Example of Analysis Support Apparatus 201)

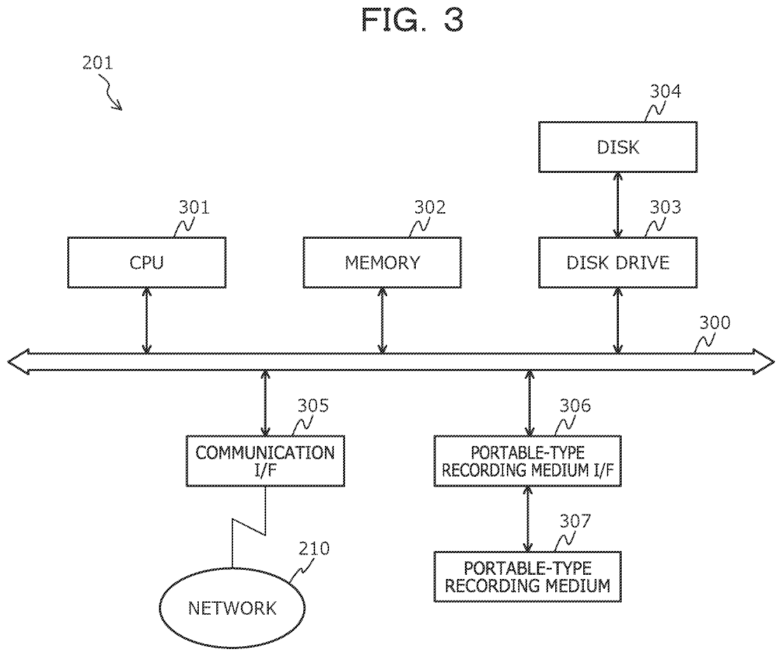

FIG. 3 is a block diagram illustrating a hardware configuration example of the analysis support apparatus 201. In FIG. 3, the analysis support apparatus 201 includes a CPU 301, a memory 302, a disk drive 303, a disk 304, a communication interface (I/F) 305, a portable-type recording medium I/F 306, and a portable-type recording medium 307. These components are coupled to one another through a bus 300.

The CPU 301 controls the entire analysis support apparatus 201. The CPU 301 may include multiple cores. The memory 302 includes, for example, a read-only memory (ROM), a random-access memory (RAM), a flash ROM, and the like. For example, the flash ROM stores a program of an operating system (OS), the ROM stores application programs, and the RAM is used as a work area for the CPU 301. When loaded by the CPU 301, the program stored in the memory 302 causes the CPU 301 to execute the processing coded in the program.

The disk drive 303 controls reading and writing of data from and to the disk 304 in accordance with the control of the CPU 301. The disk 304 stores data written under the control of the disk drive 303. Examples of the disk 304 include a magnetic disk, an optical disk, and the like.

The communication I/F 305 is coupled to the network 210 through a communication line and coupled to external computers (for example, the client apparatus 202 and the business system BS illustrated in FIG. 2) via the network 210. The communication I/F 305 functions as an interface between the network 210 and the inside of the analysis support apparatus 201 and controls input and output of data from and to the external computers. As the communication I/F 305, for example, a modem, a LAN adapter, or the like may be used.

The portable-type recording medium I/F 306 controls reading and writing of data from and to the portable-type recording medium 307 in accordance with the control of the CPU 301. The portable-type recording medium 307 stores data written under the control of the portable-type recording medium I/F 306. Examples of the portable-type recording medium 307 include a compact disc (CD)-ROM, a Digital Versatile Disk (DVD), a Universal Serial Bus (USB) memory, and the like.

The analysis support apparatus 201 may include, for example, an input device, a display, and the like, in addition to the above-described components. The client apparatus 202 illustrated in FIG. 2 may be implemented with similar hardware configuration to that of the analysis support apparatus 201. However, the client apparatus 202 includes, for example, an input device, a display, and the like in addition to the above-described components.

(Information Stored in Tables 220, 230, 240, and 250)

The information stored in the tables 220, 230, 240, and 250 will be described with reference to FIGS. 4 to 7. The tables 220, 230, 240, and 250 are built by, for example, a storage device such as the memory 302 or the disk 304.

FIG. 4 is a diagram illustrating an example of information stored in the data table 220. In FIG. 4, the data table 220 has fields of a date and time, a region, an operation section, a service name, an item, and a value, and stores item data (for example, item data 400-1 to 400-6) in time series as records by setting information in each of the fields.

The date and time specifies a date and time when a value of each of the items about the business system BS on the public cloud PbC is measured. The region specifies a region including an operation section (zone). The region is a group of geographically close operation sections, and is information with which the location of a data center, for example, is identifiable.

The operation section specifies an operation section in which the business system BS is constructed. The operation section is one of ranges into which resources are partitioned, and represents an operation section with an independent infrastructure in a region (for example, in a data center). The service name specifies the name of a service provided by the business system BS. The item specifies an item about the performance of the business system BS. An item “#-response” specifies a response of function_#(processing group #) in the business system BS. Function_#specifies any of the functions of the business system BS. The value specifies an actually measured value of the item.

For example, the item data 400-1 specifies the value “3.4” of the item “A-response” of the service name “Web_A” in the operation section “zone_A” of the region “Western Japan_1” at the date and time “2021/09/03 11:30:00”.

The item data 400-3 specifies the value “65” of the item “CPU usage rate” of the service name “instance_A” in the operation section “zone_A” of the region “Western Japan_1” at the date and time “2021/09/03 11:30:00”. Instance_A represents a virtual machine (virtual machine_A) of the business system BS.

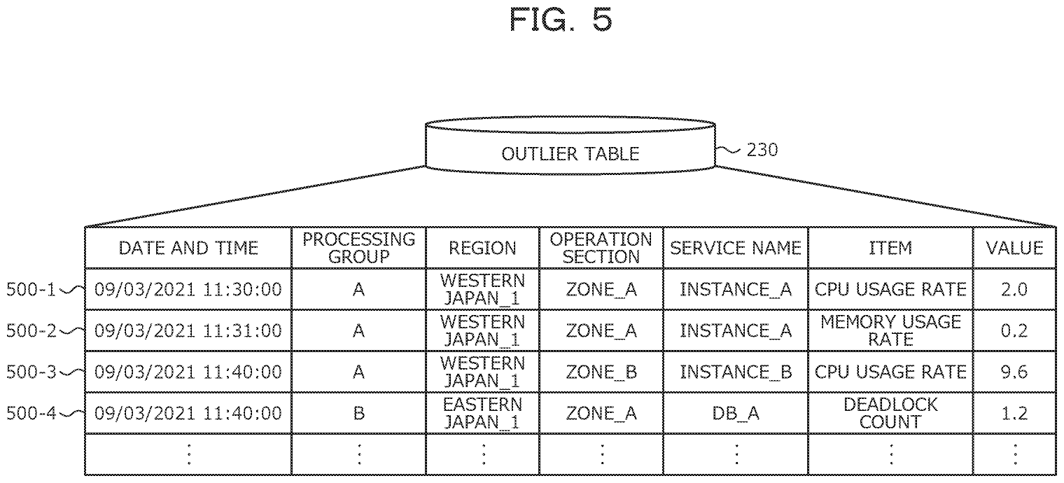

FIG. 5 is a diagram illustrating an example of information stored in the outlier table 230. In FIG. 5, the outlier table 230 has fields of a date and time, a processing group, a region, an operation section, a service name, an item, and a value, and stores outlier data (for example, outlier data 500-1 to 500-4) as records in time series by setting information in each of the fields.

The date and time indicates a date and time when a value (outlier) of each of the items about the business system of the public cloud PbC is measured. The processing group specifies a group of resources (or performance items) for function_# in the business system BS. The processing group is equivalent to a group in which resources (or performance items) used by the processes involved in function_# in the business system BS are arranged in the change order.

The region specifies a region including an operation section (zone). The operation section specifies an operation section in which the business system BS is constructed. The service name specifies the name of a service provided by the business system BS. The item specifies an item about the performance of the business system BS. The value specifies a deviation degree of an actually measured value of the item from a predicted value of the item.

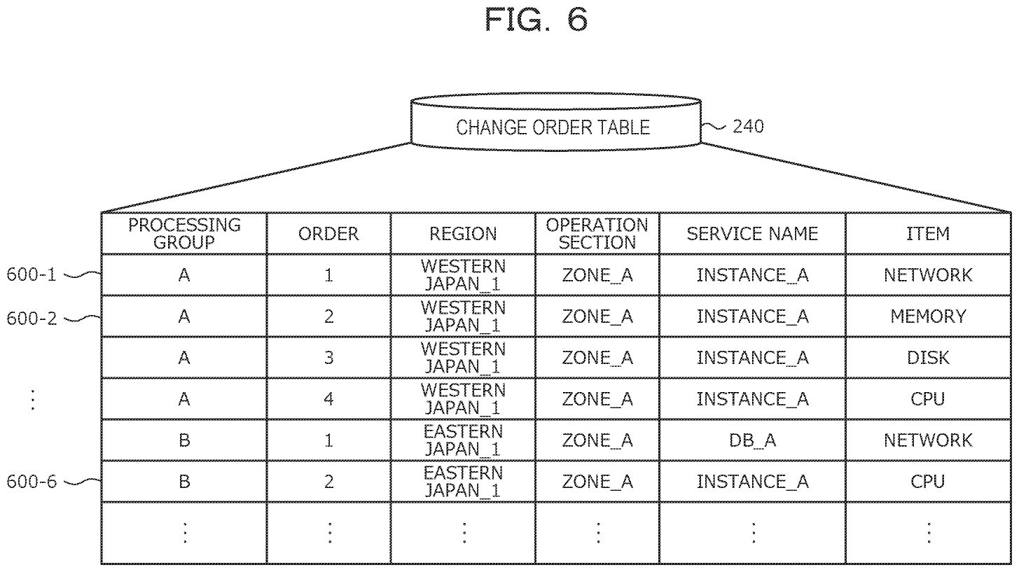

FIG. 6 is a diagram illustrating an example of information stored in the change order table 240. In FIG. 6, the change order table 240 has fields of a processing group, an order, a region, an operation section, a service name, and an item, and stores change order data (for example, change order data 600-1 to 600-6) as records by setting information in each of the fields.

The processing group specifies a group of resources (or performance items) for function_# in the business system BS. The order specifies an ordinal number of a resource (a performance item) in the order of the resources (or performance items) that change in accordance with an execution order of the processes involved in function_# in the business system BS. The region specifies a region including an operation section (zone). The operation section specifies an operation section in which the business system BS is constructed. The service name specifies the name of a service provided by the business system BS. The item specifies a resource (or a performance item).

For example, the change order data 600-1 to 600-4 specify the change order of the resources (or performance items) included in the processing group A.

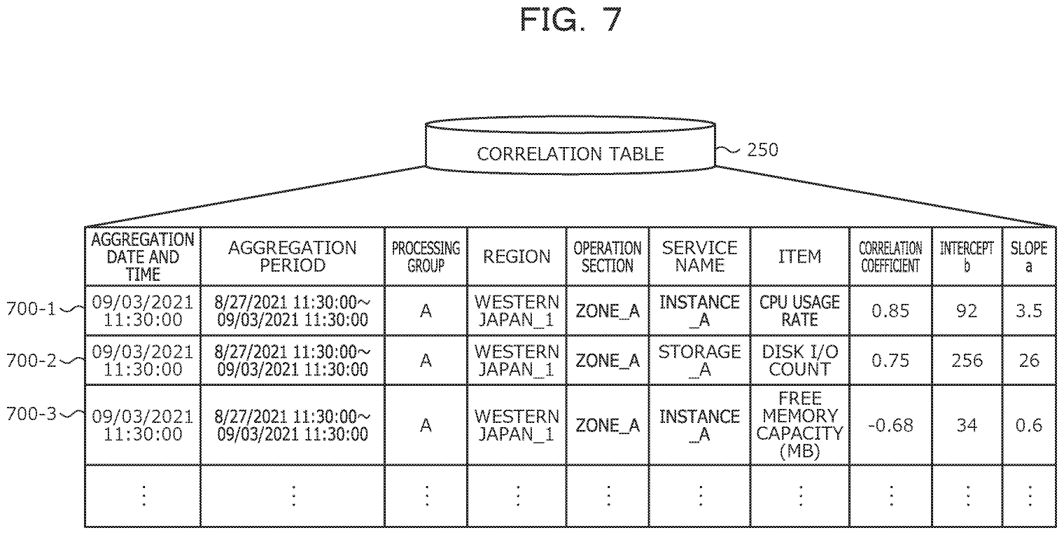

FIG. 7 is a diagram illustrating an example of information stored in the correlation table 250. In FIG. 7, the correlation table 250 has fields of an aggregation date and time, an aggregation period, a processing group, a region, an operation section, a service name, an item, a correlation coefficient, an intercept b, and a slope a. The correlation table 250 stores correlation data (for example, correlation data 700-1 to 700-3) as records by setting information in each of the fields.

The aggregation date and time specifies a date and time when the correlation data is generated. The aggregation period specifies a period for which information for generating the correlation data (a correspondence relationship between a response and a value of a performance item) is aggregated. The processing group specifies a group of resources exerting a function in the business system BS. The region specifies a region including an operation section (zone). The operation section specifies an operation section in which the business system BS is constructed.

The service name specifies the name of a service provided by the business system BS. The item specifies a performance item. The correlation coefficient indicates a degree of the correlation between the response and the value of the performance item. The intercept b and the slope a are the intercept and the slope of a regression line representing the correlation between the response and the value of the performance item.

(Analysis Sequence on Dashboard)

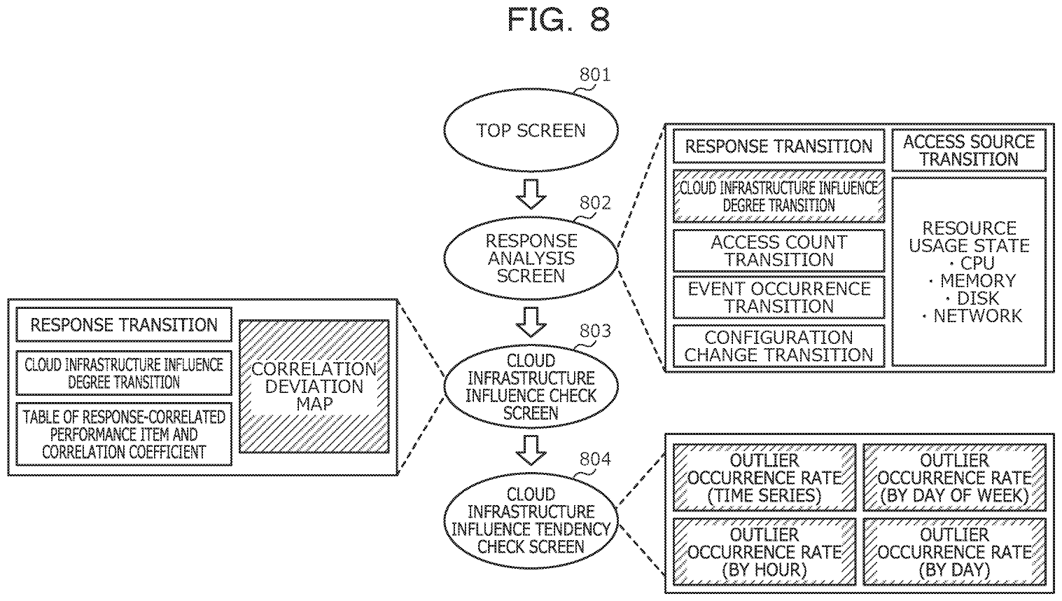

Next, with reference to FIG. 8, description will be given of a transition example of various screens displayed on the client apparatus 202 in the course of making a performance analysis of the business system BS. For example, the various screens are displayed using a dashboard (data visualization tool).

FIG. 8 is a diagram illustrating a transition example of various screens. As illustrated in FIG. 8, in the course of making a performance analysis of the business system BS, a top screen 801, a response analysis screen 802, a cloud infrastructure influence check screen 803, and a cloud infrastructure influence tendency check screen 804 are displayed on the client apparatus 202 in this order.

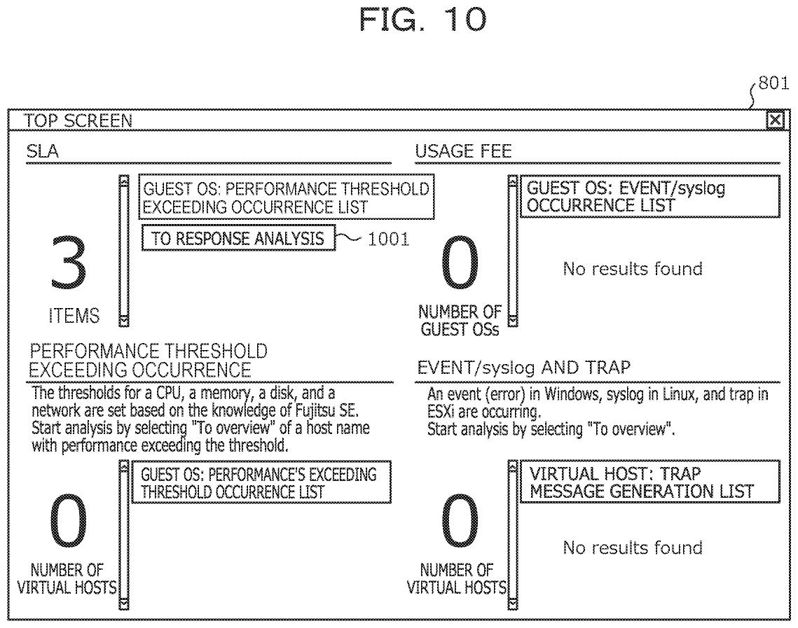

The top screen 801 is a screen for recognizing a response degradation. An example of the top screen 801 will be described later with reference to FIG. 10.

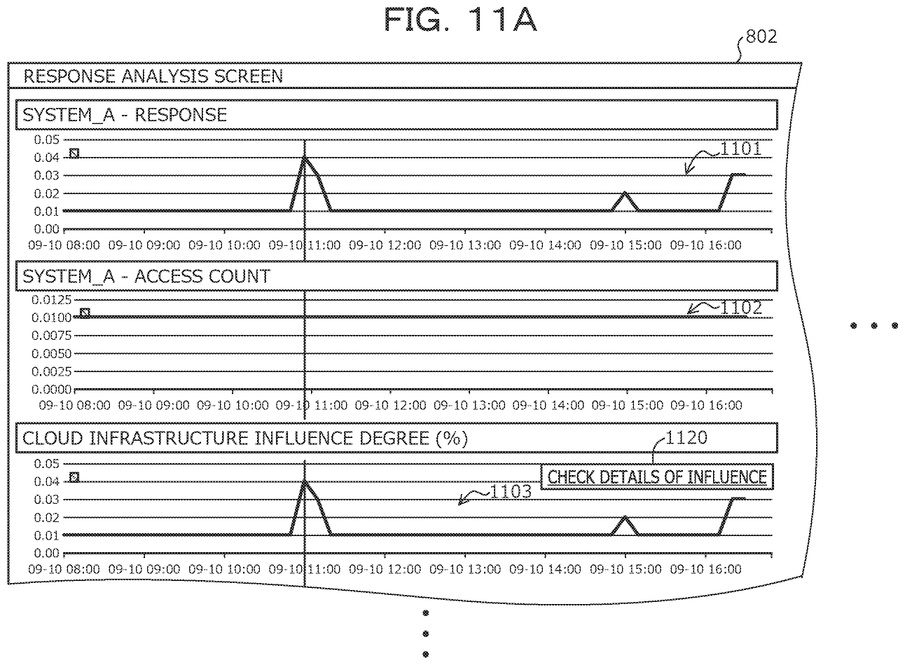

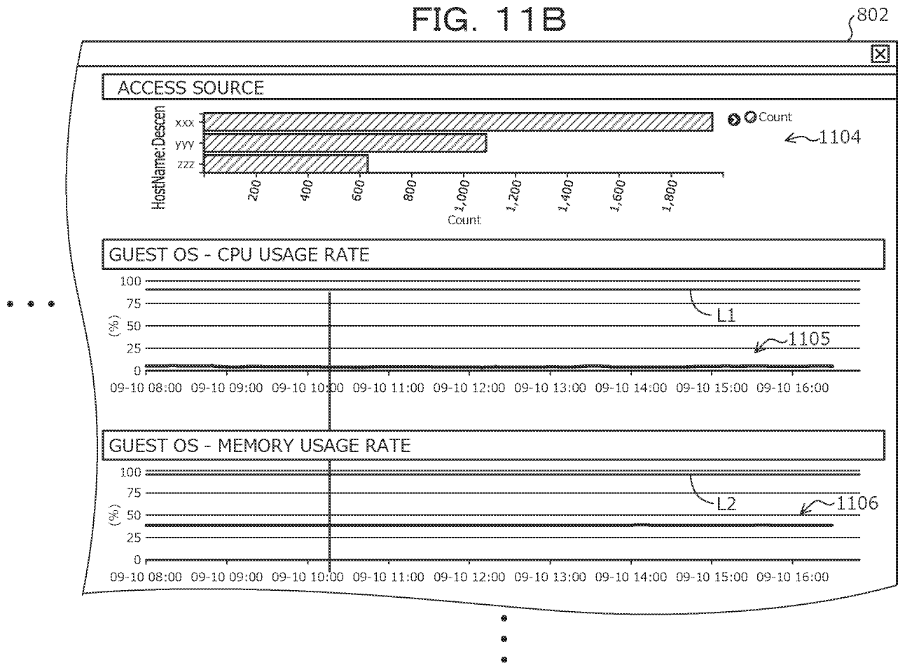

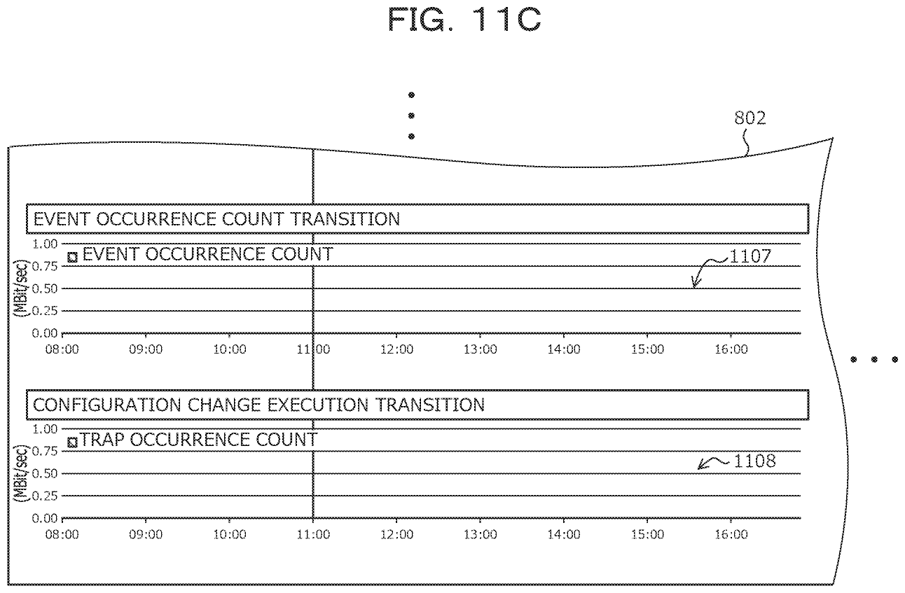

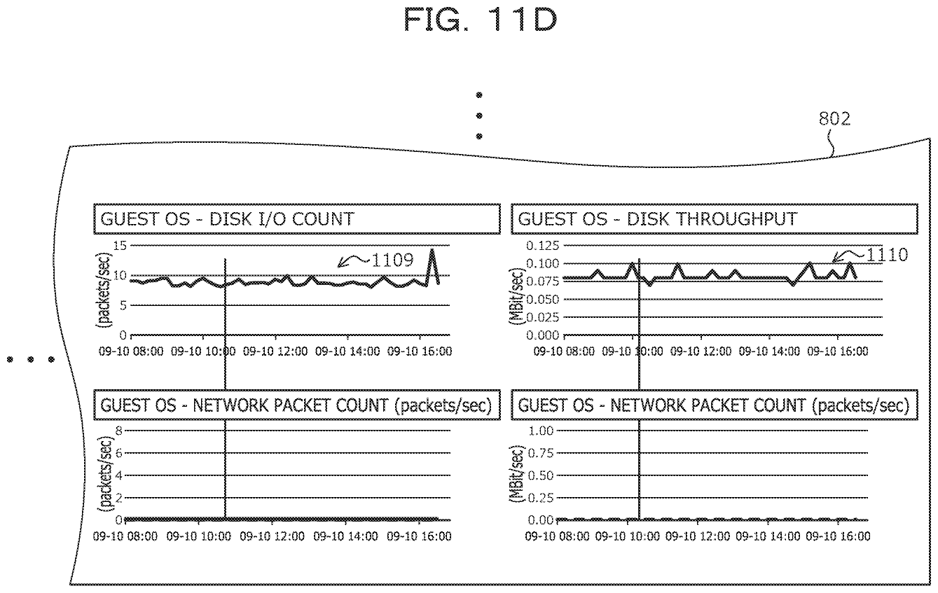

The response analysis screen 802 is a screen for determining an influence of the cloud infrastructure. The response analysis screen 802 includes, for example, a response transition, a cloud infrastructure influence degree transition, an access count transition, an event occurrence transition, a configuration change transition, an access source transition, and resource usage states (for example, the CPU, the memory, the disk, and the network). An example of the response analysis screen 802 will be described later with reference to FIGS. 11A to 11D.

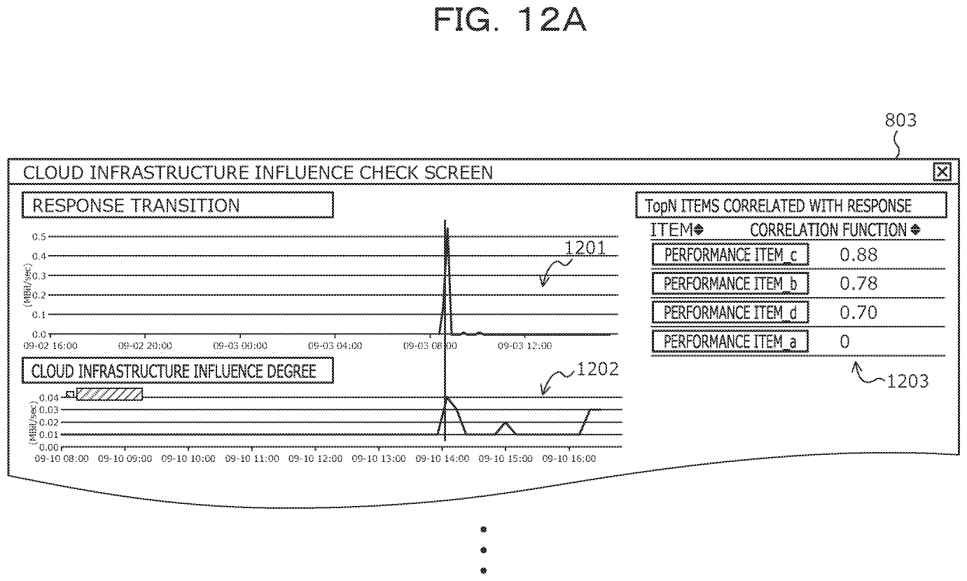

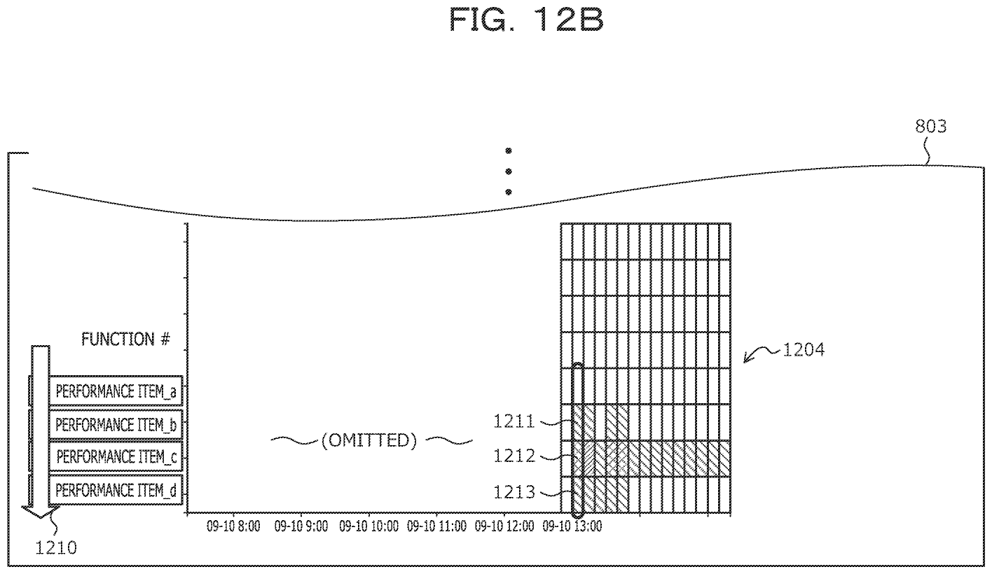

The cloud infrastructure influence check screen 803 is a screen for determining a performance item affected by the cloud infrastructure. For example, the cloud infrastructure influence check screen 803 includes a response transition, a cloud infrastructure influence degree transition, a table of a response, a correlated performance item, and a correlation coefficient, and a correlation deviation map. A screen example of the cloud infrastructure influence check screen 803 will be described later with reference to FIGS. 12A and 12B.

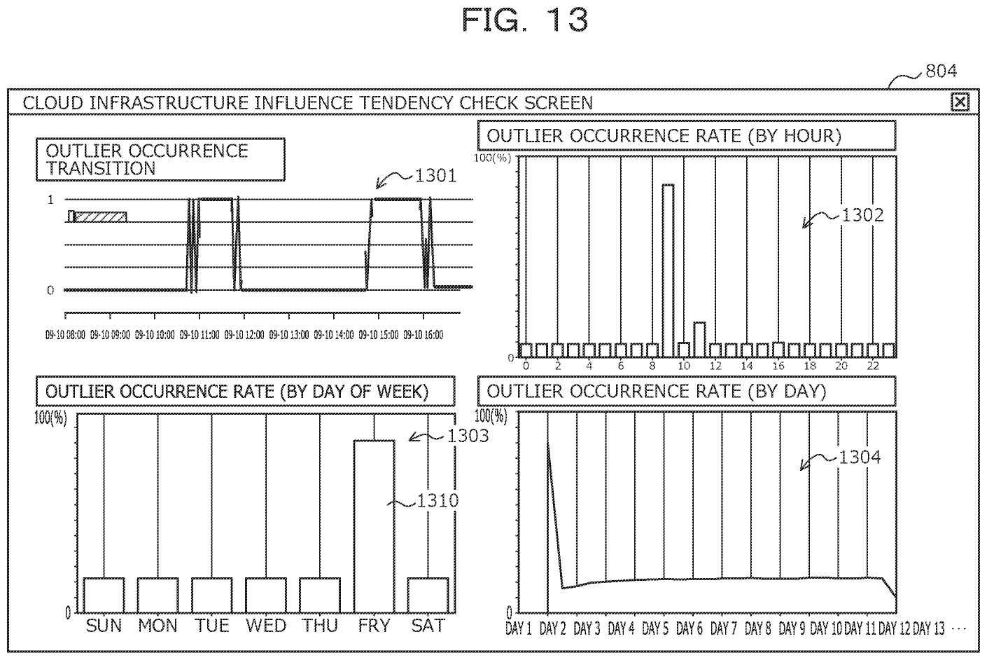

The cloud infrastructure influence tendency check screen 804 is a screen for recognizing a frequency or cycle of the influence received from the cloud infrastructure. The cloud infrastructure influence tendency check screen 804 includes, for example, an outlier occurrence rate (time series), an outlier occurrence rate (by hour), an outlier occurrence rate (by day of week), and an outlier occurrence rate (by day). A screen example of the cloud infrastructure influence tendency check screen 804 will be described later with reference to FIG. 13.

(Functional Configuration Example of Analysis Support Apparatus 201)

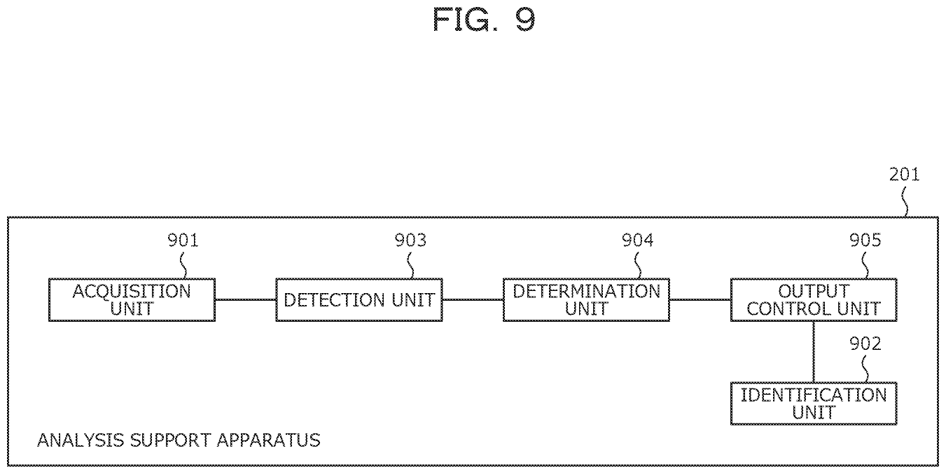

FIG. 9 is a block diagram illustrating a functional configuration example of the analysis support apparatus 201. In FIG. 9, the analysis support apparatus 201 includes an acquisition unit 901, an identification unit 902, a detection unit 903, a determination unit 904, and an output control unit 905. The acquisition unit 901 to the output control unit 905 are functions constituting a control unit. These functions are implemented, for example, by causing the CPU 301 to execute a program stored in a storage device such as the memory 302, the disk 304, or the portable-type recording medium 307 illustrated in FIG. 3 or by using the communication I/F 305. The processing results obtained by these functional units are stored, for example, in a storage device such as the memory 302 or the disk 304.

The acquisition unit 901 acquires data about performance of a target system. The target system is a system targeted for a performance analysis, and is constructed by using sharable resources. For example, the target system is the business system BS implemented by the public cloud PbC illustrated in FIG. 2.

In the following description, the “business system BS” will be taken as an example of the target system.

For example, the data includes information specifying a response of function_# in the business system BS, information specifying the actually measured values of the performance items concerning the resources used by the processes involved in function_# in the business system BS, and the like. Function_# indicates any of the functions in the business system BS, such as, for example, the data aggregation, the data reference, and the data registration.

For example, the acquisition unit 901 periodically acquires, from the business system BS, the data about the performance of the business system BS. An interval between data acquisitions may be set to arbitrary period, and is set to, for example, one minute or the like. The actually measured values of the response of each function and each of the performance items are measured by, for example, a guest OS of a virtual machine (instance) in the business system BS.

Hereinafter, the date and time when data is acquired from the business system BS may be referred to as a “collection time” in some cases. The collection time is equivalent to, for example, a date and time when the actually measured values of the response of each function and each of the performance items are measured.

For example, the acquired data is stored in the data table 220 illustrated in FIG. 4. In more detail, for example, the acquisition unit 901 stores the acquired data in accordance with the format of the data table 220. Accordingly, the item data 400-1 to 400-6 as illustrated in FIG. 4 are stored.

The identification unit 902 identifies a change order of the resources which are used by the processes involved in function_# in the business system BS, and which change in accordance with an execution order of the processes. For example, the identification unit 902 executes the processes involved in function_# in the business system BS and thereby identifies the order of the resources used by the processes. By referring to the identified order of the resources used by the processes, the identification unit 902 identifies the change order of the resources used by the processes involved in function_# in the business system BS.

There is a case where the processes involved in function_# in the business system BS use the same type of resource two or more times. In this case, when identifying the change order of the resources, the identification unit 902 may omit the same type of resource in the second and subsequent uses.

The identification unit 902 may identify the change order of the resources by patterning the performance characteristics of function_# in the business system BS by using an existing technique. The identification unit 902 may acquire the information indicating the change order of the resources via an operation input by a user using an input device (not illustrated) or via reception from the client apparatus 202. The identification unit 902 may identify the change order of the resources by referring to the acquired information.

For example, the identified change order of the resources is stored in the change order table 240 illustrated in FIG. 6 in association with function_#(processing group #) or the like in the business system BS.

The detection unit 903 detects a performance item correlated with the response of function_#among the performance items concerning the resources used by the processes involved in function_# in the business system BS. For example, the detection unit 903 extracts the item data within the aggregation period from the data table 220. The aggregation period may be set to arbitrary period, and is set to a period of one week or so, for example.

For function_#(processing group #) in the business system BS, the detection unit 903 calculates a correlation coefficient between the response of function_# and each performance item with reference to the extracted item data within the aggregation period. In more detail, for example, for function_A (processing group A), the detection unit 903 calculates a correlation coefficient between A-response and each of the performance items in instance_A with reference to the extracted item data.

Instance_A is an instance (virtual machine) that executes function_A. Examples of the performance items in instance_A include, for example, the CPU usage rate, the memory usage rate, and so forth. The detection unit 903 detects a performance item whose calculated correlation coefficient (absolute value) is equal to or greater than a threshold a as a performance item correlated with the response of function_#. The threshold a may be set to arbitrary value, and is set to a value of 0.7 or so, for example.

For each performance item correlated with the response of function_#, the detection unit 903 calculates a regression line representing the correlation between the response of function_# and the performance item with reference to the extracted item data. The detection unit 903 periodically executes the detection processing, for example. An execution interval of the detection processing may be set to arbitrary period, and is set to a time period of one week or so, for example.

The information on the detected performance item is stored in, for example, the correlation table 250. For example, the detection unit 903 stores the performance item, the correlation coefficient, and the intercept b and the slope a of the regression line in the correlation table 250 in association with the aggregation date and time, the aggregation period, the processing group #, and the like.

The determination unit 904 determines whether or not the actually measured value of the performance item specified by the acquired data is an outlier. For example, the determination unit 904 uses the correlation data in the correlation table 250 to determine whether or not the actually measured value of the performance item is an outlier in accordance with an existing technique such as the Smirnov-Grubbs test.

The performance item targeted for the outlier determination is, for example, a performance item correlated with the response of function_# in the business system BS, and is identified from the correlation table 250. Taking function_A in the business system BS as an example, the performance item targeted for the outlier determination is, for example, the CPU usage rate in instance_A.

The determination unit 904 calculates a deviation degree of the actually measured value of the performance item determined as the outlier. The deviation degree is an index value indicating how much the actually measured value of the performance item deviates from a predicted value thereof. For example, the deviation degree is represented by a ratio of the actually measured value to the predicted value (how many times the actually measured value is the predicted value). For example, the predicted value is set based on the coefficients (the slope a and the intercept b) of the regression line in the correlation table 250. In more detail, for example, the predicted value may be obtained in accordance with “a×the actually measured value+b”.

The performance item whose actually measured value is determined as the outlier and the deviation degree are stored in, for example, the outlier table 230. For example, the determination unit 904 stores the performance item and the deviation degree in the outlier table 230 in association with the date and time, the processing group #, and the like. The date and time is a date and time when the value of the performance item determined as the outlier is measured.

The output control unit 905 outputs a cloud infrastructure influence degree for the business system BS. The cloud infrastructure influence degree is an index value indicating the magnitude of a degree of influence of the cloud infrastructure on the business system BS. The larger the value of the cloud infrastructure influence degree, the higher the rick due to the influence of the cloud infrastructure.

If the business system BS is affected by the cloud infrastructure, it is highly likely that not all the performance items will be affected at the same time, but only one or some performance items (resources) will be affected. In the business system BS, when a certain resource is not sufficiently available due to an influence of the cloud infrastructure, the response of a process (function_#) that uses the certain resource is affected.

There is a certain correlation between the response of function_# in the business system BS and each of the various performance items. The value may presumably deviate from the correlation in a case where some problem occurs in the business system BS or where a resource is not available due to the influence of the cloud infrastructure. For this reason, the output control unit 905 calculates the cloud infrastructure influence degree based on the deviation from the correlation in the normal state.

For example, regarding a time t targeted for a performance analysis of the business system BS, the output control unit 905 calculates, as the cloud infrastructure influence degree, a ratio of functions that use a resource of a performance item deviating from the correlation to a function group (all the processes) in the business system BS. The performance item deviating from the correlation is a performance item whose actually measured value at the time t is an outlier of the correlation with the response of function_# in the business system BS. For example, function_# is a function with a degraded response in the function group in the business system BS.

For example, the function group in the business system BS is assumed to include “data aggregation, data reference, and data registration”. The resource of the performance item whose actually measured value at the time t deviates from the correlation is assumed to be a “network”. The performance item whose actually measured value at the time t deviates from the correlation is identified from the outlier table 230, for example. In the function group including “data aggregation, data reference, and data registration” in the business system BS, the functions “data reference and data registration” are assumed to use the resource “network”. In this case, the output control unit 905 calculates the cloud infrastructure influence degree of “0.67 (≈2/3)” by dividing “2” that is the number of the functions using the resource “network” by “3” that is the total number of the functions in the business system BS.

The output control unit 905 outputs the calculated cloud infrastructure influence degree of “0.67” in association with the time t. In this output, the output control unit 905 may further output the actually measured value of the performance item concerning the resource used by the process involved in function_# at the time t.

When an outlier occurs in a first one of the performance items switching over from one to another in the sequence of processes for one request, outliers are highly likely to occur in the second and subsequent performance items. For this reason, the output control unit 905 determines that the influence on the response of a certain function is the same regardless of whether outliers occur in all the performance items or an outlier occurs in only one of the performance items. For example, regardless of whether outliers occur in all the performance items or an outlier occurs in one performance item, the output control unit 905 determines that the function is a function that uses the resource of the performance item deviating from the correlation.

In more detail, for example, the output control unit 905 extracts the item data of a target processing group within a target period from the data table 220. The target processing group may be arbitrarily designated, and is, for example, the processing group # for function_# with a degraded response. For example, the target processing group is designated on the top screen 801.

The target period may be arbitrarily designated and is, for example, a period targeted for an analysis of a response delay of function_# in the business system BS. For example, the target period is designated by the client apparatus 202. The item data within the target period is item data containing time points in a range from the start date and time to the end date and time of the target period.

After that, the output control unit 905 extracts the change order data of the target processing group from the change order table 240. For example, when the target processing group is the “processing group A”, the output control unit 905 extracts the change order data 600-1 to 600-4 of the processing group A from the change order table 240.

Next, the output control unit 905 extracts, from the outlier table 230, the outlier data within the target period of the performance item concerning the resource specified by each record of the extracted change order data. A correspondence relationship between a resource and a performance item is set in advance, for example. For example, the performance item “CPU usage rate” is set for the resource “CPU”.

The performance item “memory usage rate” is set for the resource “memory”. The performance items “network packet count and network throughput” are set for the resource “network”. The performance items “disk I/O count and disk throughput” are set for the resource “disk”.

Then, for each date and time (collection time) specified by the extracted outlier data, the output control unit 905 identifies the processing group including the resource of the performance item specified by the outlier data with reference to the change order table 240, and calculates the number of the identified processing groups. The date and time specified by the outlier data corresponds to the time t described above.

The output control unit 905 calculates the total number of the processing groups with reference to the change order table 240. The total number of the processing groups is equivalent to the number of the functions in the business system BS. For each date and time specified by the extracted outlier data, the output control unit 905 calculates the cloud infrastructure influence degree of the business system BS by dividing the number of the identified processing groups by the total number of the processing groups.

The output control unit 905 sets “0” as the cloud infrastructure influence degree at a date and time (collection time) when no outlier occurs in the target period. Consequently, for each collection time in the target period, the output control unit 905 calculates the cloud infrastructure influence degree of the business system BS at the collection time.

After that, the output control unit 905 creates a cloud infrastructure influence degree transition graph in which the calculated cloud infrastructure influence degrees at the respective collection times are presented in time series. The output control unit 905 outputs the response analysis screen 802 (see FIG. 8) including the created cloud infrastructure influence degree transition graph to the client apparatus 202.

By referring to the data table 220, the output control unit 905 may create a resource usage state graph in which the actually measured values of a performance item concerning each of the resources used by the processes involved in function_# at the respective collection times in the target period are presented in time series. The output control unit 905 may output the response analysis screen 802 including the created resource usage state graph to the client apparatus 202.

The output control unit 905 may create an access count transition graph in which the access counts at the respective collection times in the target period are presented in time series. The output control unit 905 may output the response analysis screen 802 including the created access count transition graph to the client apparatus 202. For example, the access count is the number of accesses from users to the business system BS. For example, the information specifying the access count to the business system BS is acquired from the business system BS.

The output control unit 905 may create an event occurrence transition graph in which event occurrence counts in the business system BS in the target period are presented in time series. The output control unit 905 may output the response analysis screen 802 including the created event occurrence transition graph to the client apparatus 202. The event occurrence count indicates the number of events occurring per unit time in the business system BS. The event is, for example, an error event. The information specifying the event occurrence count in the target system is acquired from, for example, the business system BS.

The output control unit 905 may create a configuration change transition graph in which configuration change occurrence counts in the business system BS in the target period are presented in time series. The output control unit 905 may output the response analysis screen 802 including the created configuration change transition graph to the client apparatus 202. The configuration change occurrence count indicates how many times the configuration of the business system BS is changed per unit time. The information specifying the configuration change occurrence count of the target system is acquired from, for example, the business system BS.

An example of the response analysis screen 802 will be described later with reference to FIGS. 11A to 11D.

Regarding the time t, the output control unit 905 outputs information with which performance items having outliers among the performance items concerning the resources used by the processes involved in function_# are identifiable in accordance with the identified change order of the resources. For example, when outputting the information with which the performance items having the outliers at time t are identifiable, the output control unit 905 outputs the performance items having the outliers such that an order relationship among the performance items in accordance with the change order of the resources is identifiable. In this output, the output control unit 905 may output each of the performance items in a mode corresponding to the deviation degree of the actually measured value from the predicted value of the performance item with respect to the response of function_# at the time t.

The time t is a time targeted for a performance analysis of the business system BS, and is, for example, a time targeted for an analysis of a response delay of function_#. The performance item having an outlier is a performance item whose actually measured value at the time t deviates from the correlation with the response of function_#. To output in the mode corresponding to the deviation degree means, for example, to output in a different color, output in a different grayscale, or output in a different font depending on the deviation degree.

For example, a change order of resources used by processes involved in function_# is assumed to be “resource_a→resource_b→resource_c→resource_d”. It is also assumed that a performance item concerning resource_a is “performance item_a”, a performance item concerning resource_b is “performance item_b”, performance items concerning resource_c are “performance item_c-1 and performance item_c-2”, and a performance item concerning resource_d is “performance item_d”.

First, the performance items whose actually measured values at the time t are outliers of the correlations with the response of function_# are assumed to be “performance item_a and performance item_d”. In this case, for example, the output control unit 905 may output performance item_a and performance item_d having the outliers at the time t while arranging them in the order of “performance item_a→performance item_d”.

Instead, the performance items whose actually measured values at the time t are outliers of the correlations with the response of function_# are assumed to be “performance item_b, performance item_c-1, and performance item_c-2”. In this case, for example, the output control unit 905 may output performance item_b, performance item_c-1, and performance item_c-2 having the outliers at the time t in the order of “performance item_b→performance item_c-1 and performance item_c-2”.

In more detail, for example, the output control unit 905 extracts the outlier data of the target processing group within the target period from the outlier table 230. The output control unit 905 refers to the change order table 240 and creates a correlation deviation map in which performance items having outliers at every date and time specified by the extracted outlier data are presented such that an order relationship among the performance items is identifiable.

In this creation, for example, the output control unit 905 may refer to the values of the extracted outlier data and create the correlation deviation map in which each of the performance items having the outliers is expressed in a color density corresponding to the magnitude of the deviation degree. The output control unit 905 outputs the cloud infrastructure influence check screen 803 (see FIG. 8) including the created correlation deviation map to the client apparatus 202.

An example of the cloud infrastructure influence check screen 803 will be described later with reference to FIGS. 12A and 12B.

The output control unit 905 receives selection of any performance item among the performance items having the outliers. The performance item is selected on, for example, the cloud infrastructure influence check screen 803. For example, a performance item determined to have been affected by the cloud infrastructure is selected from among the performance items concerning the resources used by the processes involved in function_#targeted for an analysis of a response delay.

For the selected performance item, the output control unit 905 calculates an outlier occurrence rate by predetermined time range in the target period based on data specifying time points at which the actually measured values measured in the target period are the outliers. The outlier is a value deviating from the correlation with the response of function_#. The predetermined time range may be arbitrarily set and is, for example, hour, day of week, day, or the like. The output control unit 905 outputs the calculated outlier occurrence rate by predetermined time range in association with the selected performance item.

For example, “hour” is set as the predetermined time range. In this case, the outlier occurrence rate by N-th hour may be calculated by using, for example, the following formula (1). Here, N is, for example, any one of 0, 1, 2, . . . , and 23.

Outlier Occurrence Rate by N-th Hour=(the number of days on each of which an outlier occurs for the N-th hour in the target period)/(number of days in the target period)×100 (1)

Instead, “day of week” is set as the predetermined time range. In this case, the outlier occurrence rate by specific day of week may be calculated by using, for example, the following formula (2). Here, the specific day of week is, for example, any one of Monday, Tuesday, Wednesday, Thursday, Friday, Saturday, and Sunday.

Outlier Occurrence Rate by Specific Day of Week=(the number of the specific days on each of which an outlier occurs in the target period)/(the number of the specific days in the target period)×100 (2)

Instead, “day” is set as the predetermined time range. In this case, the outlier occurrence rate by M-th day may be calculated by using, for example, the following formula (3). Here, the M-th day is, for example, any one of the first day to the 31st day.

Outlier Occurrence Rate by M-th Day=(the number of the M-th days on each of which an outlier occurs in the target period)/(the number of the M-th days in the target period)×100 (3)

The predetermined time range may be equal to a time interval (for example, one minute) for measuring the values of the performance items. In this case, for the selected performance item, the output control unit 905 may output time-series data indicating whether or not an outlier occurs at each collection time in the target period.

In more detail, for example, the output control unit 905 extracts the outlier data of the selected performance item in the target processing group within the target period from the outlier table 230. For the selected performance item, the output control unit 905 creates an outlier occurrence rate (by hour) graph presenting an outlier occurrence rate by hour in the target period based on the extracted outlier data. The output control unit 905 outputs the cloud infrastructure influence tendency check screen 804 (see FIG. 8) including the outlier occurrence rate (by hour) graph to the client apparatus 202.

Instead, for the selected performance item, the output control unit 905 creates an outlier occurrence rate (by day of week) graph presenting an outlier occurrence rate by day of week in the target period based on the extracted outlier data. The output control unit 905 may output the cloud infrastructure influence tendency check screen 804 including the created outlier occurrence rate (by day of week) graph to the client apparatus 202.

Instead, for the selected performance item, the output control unit 905 creates an outlier occurrence rate (by day) graph presenting an outlier occurrence rate by day in the target period based on the extracted outlier data. The output control unit 905 may output the cloud infrastructure influence tendency check screen 804 including the created outlier occurrence rate (by day) graph to the client apparatus 202.

An example of the cloud infrastructure influence tendency check screen 804 will be described later with reference to FIG. 13.

The functional units of the analysis support apparatus 201 described above may be implemented by multiple computers (for example, the analysis support apparatus 201 and the client apparatus 202) in the analysis support system 200.

(Screen Examples of Various Screens)

Next, the screen examples of the various screens displayed on the client apparatus 202 will be described. First, the screen example of the top screen 801 will be described by using FIG. 10.

FIG. 10 is a diagram illustrating the screen example of the top screen. In FIG. 10, the top screen 801 is an example of an operation screen for determining a degradation in a response of function_# in the business system BS. The top screen 801 displays the number of items in each of which the performance exceeds a threshold for function_# in the business system BS.

The item to be monitored may be arbitrarily set. Here, considered is a case where the response of function_# is set as the item to be monitored and the response exceeds the threshold. From the top screen 801, a user may recognize that a response delay of function_# in the business system BS occurs.

When the user selects a link 1001 by an operation input on the top screen 801, the response analysis screen 802 as illustrated in FIGS. 11A to 11D is displayed.

FIGS. 11A to 11D are explanatory diagrams illustrating a screen example of a response analysis screen. In FIGS. 11A to 11D, the response analysis screen 802 is an example of an operation screen for determining an influence of the cloud infrastructure on the business system BS. Assumed herein is a case where a period of 09/10/08:00 to 09/10/16:00 is designated as the target period.

For example, as illustrated in FIG. 11A, the response analysis screen 802 includes a response transition graph 1101, an access count transition graph 1102, and a cloud infrastructure influence degree transition graph 1103. The response transition graph 1101 indicates a temporal change in the response of function_# in the target period (unit: [sec]).

The access count transition graph 1102 indicates a temporal change in the access count to the business system BS in the target period (unit: [count/min]). The cloud infrastructure influence degree transition graph 1103 indicates a temporal change in the cloud infrastructure influence degree on the business system BS in the target period (unit: [%]).

As illustrated in FIG. 11B, the response analysis screen 802 includes an access source transition graph 1104 and resource usage state graphs 1105 and 1106. The access source transition graph 1104 is information for determining a relationship between a physical distance (region and access source) and a response.

The resource usage state graph 1105 indicates a temporal change in the CPU usage rate of an instance in the target period (unit: [%]). The instance is an instance (virtual machine) that executes function_#. A line L1 indicates a threshold for the CPU usage rate. The resource usage state graph 1106 indicates a temporal change in the memory usage rate of the instance in the target period (unit: [%]). A line L2 indicates a threshold for the memory usage rate.

As illustrated in FIG. 11C, the response analysis screen 802 includes an event occurrence transition graph 1107 and a configuration change transition graph 1108. The event occurrence transition graph 1107 indicates a temporal change in the event occurrence count in the target period. The event occurrence transition graph 1107 is information for recognizing a relationship between a failure and a response. Here, no event occurs. The configuration change transition graph 1108 indicates a temporal change in the configuration change occurrence count in the target period. The configuration change transition graph 1108 is information for recognizing a relationship between a configuration change and a response. Here, no configuration change occurs.

As illustrated in FIG. 11D, the response analysis screen 802 includes a resource usage state graph 1109 and a resource usage state graph 1110. The resource usage state graph 1109 indicates a temporal change in the disk I/O count of the instance in the target period (unit: [count/sec]). The resource usage state graph 1110 indicates a temporal change in disk throughput of the instance in the target period (unit: [MB/sec]).

Although not illustrated, the response analysis screen 802 may include a graph indicating a temporal change in the network packet count of the instance in the target period and a graph indicating a temporal change in the network throughput of the instance in the target period.

Using the response analysis screen 802, the user may compare the cloud infrastructure influence degree transition graph 1103 with the other graphs 1102 and 1104 to 1110 to distinguish whether the response degradation of function_# is due to a problem of the own system or a problem of a cloud infrastructure.

For example, when the own system has a problem and is not affected by the cloud infrastructure, the user may determine to investigate the own system. When the own system has a problem and is also affected by the cloud infrastructure, the user may determine to investigate the own system. When the own system does not have a problem but is affected by the cloud infrastructure, the user may determine to investigate the influence of the cloud infrastructure.

In this example, the influence of the cloud infrastructure occurs in conjunction with the response degradation. In contrast, the other items do not change in conjunction with the response. For this reason, the user may infer that there is a possibility that the own system had no problem and the response is delayed due to the influence of the cloud infrastructure, and may determine to investigate the influence of the cloud infrastructure.

When the user selects a link 1120 by an operation input on the response analysis screen 802, the cloud infrastructure influence check screen 803 as illustrated in FIG. 12A and FIG. 12B is displayed.

FIGS. 12A and 12B are explanatory diagrams illustrating a screen example of a cloud infrastructure influence check screen. In FIGS. 12A and 12B, the cloud infrastructure influence check screen 803 is an example of an operation screen for determining a performance item affected by the cloud infrastructure.

For example, as illustrated in FIG. 12A, the cloud infrastructure influence check screen 803 includes a response transition graph 1201, a cloud infrastructure influence degree transition graph 1202, and a correlation coefficient table 1203. The response transition graph 1201 indicates a temporal change in the response of function_# in the target period (unit: [sec]).

The cloud infrastructure influence degree transition graph 1202 indicates a temporal change in the cloud infrastructure influence degree of the business system BS in the target period (unit: [%]). The correlation coefficient table 1203 indicates correlation coefficients of the respective performance item_c, performance item_b, and performance item_d correlated with the response of function_#.

As illustrated in FIG. 12B, the cloud infrastructure influence check screen 803 includes a correlation deviation map 1204. The correlation deviation map 1204 is information in which cells representing performance items having outliers at every date and time (collection time) in the target period are arranged in accordance with the change order of the resources used by the processes involved in function_# such that an order relationship among the performance items is identifiable.

In the correlation deviation map 1204, a cell representing a performance item having an outlier is displayed with a color density corresponding to the magnitude of the deviation degree. The deviation degree is an index value indicating how much the actually measured value of the performance item deviates from a predicted value thereof. In FIG. 12B, a part of the correlation deviation map 1204 is extracted and presented.

The performance items concerning the resources used by the processes involved in function_# are “performance item_a, performance item_b, performance item_c, and performance item_d”. A change order of performance item_a, performance item_b, performance item_c, and performance item_d in accordance with the change order of the resources used by the processes involved in function_# is “performance item_a→performance item_b→performance item_c→performance item_d”, which is indicated by an arrow 1210. Among performance item_a, performance item_b, performance item_c, and performance item_d, performance item_b, performance item_c, and performance item_d are performance items correlated with the response of function_#.

In the correlation deviation map 1204, for function_#(processing group), the cells representing the respective performance item_b, performance item_c, and performance item_d having outliers are displayed in the change order. This makes it possible for the user to recognize the performance item that deviated first from the correlation with the response in the normal state, and determine that the performance item is affected by the cloud infrastructure.

For example, cells 1211, 1212, and 1213 representing the respective performance item_b, performance item_c, and performance item_d having outliers at a time “13:00, September 10” are displayed in the change order. In this case, the user may determine that the first deviating performance item_b among performance item_b, performance item_c, and performance item_d is affected by the cloud infrastructure. In more detail, for example, the user may infer that a deviation of performance item_b led to deviations of performance item_c and performance item_d, and therefore determine that performance item_b is affected by the cloud infrastructure.

In the correlation deviation map 1204, the color density of each cell varies depending on the magnitude of the deviation degree. For example, the color of each cell is darkest when the deviation degree is 2 or more. When the deviation degree is less than 2, the color of the cell becomes lighter as the deviation degree decrements by 0.5.

Thus, in a case where, for example, the color of the cell 1212 is significantly darker than those of the cells 1211 and 1213, the user may determine that the second deviating performance item_c is likely to be also affected by the cloud infrastructure, and has to be investigated. In a case where the correlation coefficient of performance item_c is larger than that of performance item_b according to the correlation coefficient table 1203, the user may determine that the second deviating performance item_c is likely to be also affected by the cloud infrastructure, and has to be investigated.

When the user selects any one of performance item_b, performance item_c, and performance item_d having the outliers by an operation input on the cloud infrastructure influence check screen 803, the cloud infrastructure influence tendency check screen 804 as illustrated in FIG. 13 is displayed. Assumed herein is a case where performance item_b is selected.

FIG. 13 is a diagram illustrating a screen example of a cloud infrastructure influence tendency check screen. In FIG. 13, the cloud infrastructure influence tendency check screen 804 is an example of an operation screen for recognizing a frequency or cycle of the influence received from the cloud infrastructure regarding performance item_b.

For example, the cloud infrastructure influence tendency check screen 804 includes an outlier occurrence transition graph 1301, an outlier occurrence rate (by hour) graph 1302, an outlier occurrence rate (by day of week) graph 1303, and an outlier occurrence rate (by day) graph 1304. The outlier occurrence transition graph 1301 is information on performance item_b indicating whether or not an outlier occurs at each collection time in the target period.

The outlier occurrence rate (by hour) graph 1302 is information on performance item_b indicating an outlier occurrence rate by hour in the target period. The outlier occurrence rate (by day of week) graph 1303 is information on performance item_b indicating an outlier occurrence rate by day of week in the target period. The outlier occurrence rate (by day) graph 1304 is information on performance item_b indicating an outlier occurrence rate by day in the target period.

With the cloud infrastructure influence tendency check screen 804, the user may check whether the outliers tend to occur in a specific hour, a specific day of week, or a specific day important for the own system. In a case where the outliers occur in an important hour or the like, the user may reconsider a contract change for using a dedicated operation section or the like as appropriate.

For example, from the outlier occurrence rate (by hour) graph 1302, the user may recognize that the response changed due to the influence of the cloud infrastructure in the hours 9:00 to 12:00. For example, in a case where these hours coincide with the business time of the own system, the user may reconsider a change of the operation section or a change to use a dedicated operation section.

From the outlier occurrence rate (by day of week) graph 1303, the user may recognize that the influence of the cloud infrastructure tends to concentrate on Fridays. From the outlier occurrence rate (by day) graph 1304, the user may recognize that the influence of the cloud infrastructure tends to concentrate at the beginning of the month.

For example, when a graph of any day of the week (for example, a graph 1310) in the outlier occurrence rate (by day of week) graph 1303 is selected on the cloud infrastructure influence tendency check screen 804, the other statistical graphs may be also switched in conjunction with the selection to redraw information on only the selected day of the week. Similarly, the time range may be narrowed down by hour or day.

(Various Processing Procedures of Analysis Support Apparatus 201)

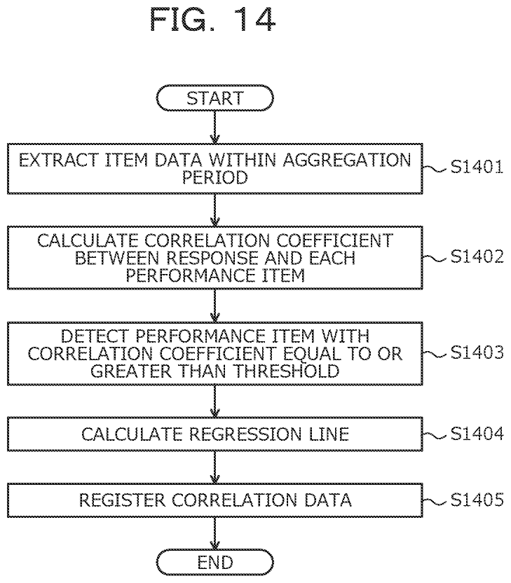

Next, various processing procedures of the analysis support apparatus 201 will be described with reference to FIGS. 14 to 19. First, a correlation calculation processing procedure of the analysis support apparatus 201 will be described with reference to FIG. 14. The correlation calculation processing of the analysis support apparatus 201 is executed at regular time intervals, for example, one day to one week.

FIG. 14 is a flowchart illustrating an example of the correlation calculation processing procedure of the analysis support apparatus 201. In the flowchart in FIG. 14, first, the analysis support apparatus 201 extracts item data within an aggregation period from the data table 220 (step S1401). For example, the aggregation period is the most recent period of one week or so. For function_#(processing group #) in the business system BS, the analysis support apparatus 201 calculates a correlation coefficient between the response of function_# and each performance item by referring to the extracted item data within the aggregation period (step S1402).

The analysis support apparatus 201 detects a performance item whose calculated correlation coefficient (absolute value) is equal to or greater than a threshold a as a performance item correlated with the response of function_#(step S1403). For the performance item correlated with the response of function_#, the analysis support apparatus 201 calculates a regression line representing the correlation between the response of function_# and the performance item by referring to the extracted item data within the aggregation period (step S1404).

After that, the analysis support apparatus 201 registers the correlation data on the detected performance item into the correlation table 250 (step S1405), and ends the series of processing according to this flowchart. For example, the correlation data contains the calculated correlation coefficient, the intercept b and the slope a of the regression line, and the like.

Thus, the analysis support apparatus 201 may register the correlation data on the performance item correlated with the response of function_#(processing group #) in the business system BS.

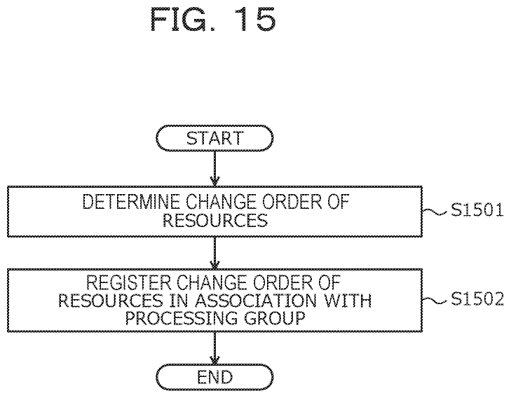

Next, a change order identification processing procedure of the analysis support apparatus 201 will be described with reference to FIG. 15. For example, the change order identification processing of the analysis support apparatus 201 is executed at the start of operation of the business system BS or at the time of a configuration change of the business system BS.

FIG. 15 is a flowchart illustrating an example of the change order identification processing procedure of the analysis support apparatus 201. In the flowchart in FIG. 15, first, the analysis support apparatus 201 identifies the change order of the resources which are used by the processes involved in function_# in the business system BS and which change in accordance with an execution order of the processes (step S1501).

The analysis support apparatus 201 registers the identified change order of the resources in the change order table 240 in association with the processing group #(function_#) (step S1502), and ends the series of processing according to this flowchart.

Thus, the analysis support apparatus 201 may identify the change order of the performance items concerning the resources which are used by the processes involved in function_# and which change in accordance with the execution order of the processes. A correspondence relationship between a resource and a performance item concerning the resource is set in advance and stored in a storage device such as the memory 302 or the disk 304, for example. In step S1501, the analysis support apparatus 201 may identify the change order of the performance items concerning the resources.

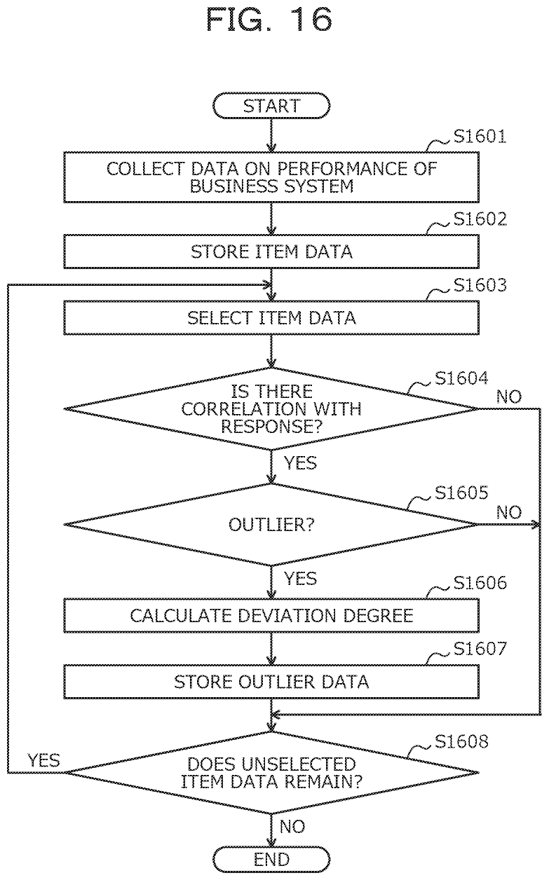

Next, an outlier calculation processing procedure of the analysis support apparatus 201 will be described with reference to FIG. 16. For example, the outlier calculation processing of the analysis support apparatus 201 is executed every time the data on the performance of the business system BS is collected from the business system BS (for example, every minute).

FIG. 16 is a flowchart illustrating an example of the outlier calculation processing procedure of the analysis support apparatus 201. In the flowchart in FIG. 16, first, the analysis support apparatus 201 collects the data on the performance of the business system BS (step S1601). After that, the analysis support apparatus 201 stores the collected data as item data in accordance with the format of the data table 220 (step S1602).

From the item data stored in step S1602, the analysis support apparatus 201 selects unselected item data yet to be selected (step S1603). By referring to the correlation table 250, the analysis support apparatus 201 determines whether or not the performance item specified by the selected item data is correlated with the response of function_# in the business system BS (step S1604).

If the performance item is not correlated with the response (step S1604: No), the analysis support apparatus 201 proceeds to step S1608. On the other hand, if the performance item is correlated with the response (step S1604: Yes), the analysis support apparatus 201 determines whether or not the value (actually measured value) of the performance item specified by the selected item data is an outlier according to an existing technique such as the Smirnov-Grubbs test (step S1605).

If the value is not an outlier (step S1605: No), the analysis support apparatus 201 proceeds to step S1608. On the other hand, if the value is an outlier (step S1605: Yes), the analysis support apparatus 201 calculates a deviation degree of the actually measured value of the performance item from the predicted value thereof based on the coefficients (the slope a and the intercept b) of the regression line in the correlation table 250 (step S1606).

The analysis support apparatus 201 stores the outlier data on the performance item determined as the outlier in the outlier table 230 (step S1607). Subsequently, the analysis support apparatus 201 determines whether or not there is unselected item data yet to be selected among the item data stored in step S1602 (step S1608).

If there is unselected item data (step S1608: Yes), the analysis support apparatus 201 returns to step S1603. On the other hand, if there is no unselected item data (step S1608: No), the analysis support apparatus 201 ends the series of processing according to this flowchart.

Thus, the analysis support apparatus 201 may register information on an outlier among the actually measured values of the performance item correlated with the response of function_# in the business system BS.

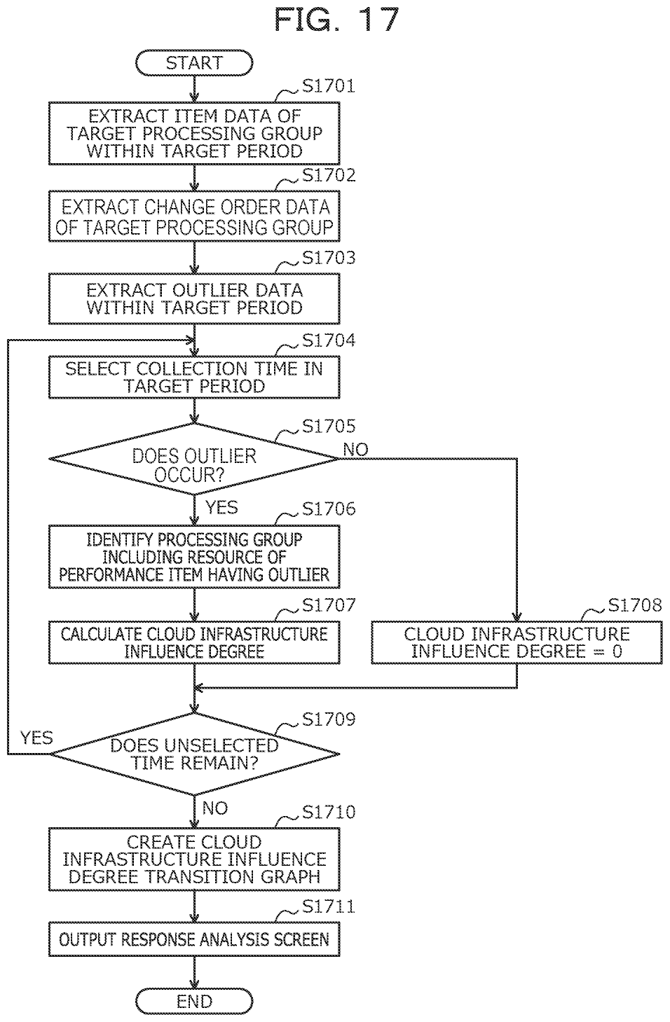

Next, a first output control processing procedure of the analysis support apparatus 201 will be described with reference to FIG. 17. For example, the first output control processing is processing for displaying the response analysis screen 802 as illustrated in FIGS. 11A to 11D on the client apparatus 202.

FIG. 17 is a flowchart illustrating an example of the first output control processing procedure of the analysis support apparatus 201. In the flowchart in FIG. 17, first, the analysis support apparatus 201 extracts the item data of a target processing group within a target period from the data table 220 (step S1701). For example, the target processing group is the processing group # for function_# with the response degraded.

After that, the analysis support apparatus 201 extracts the change order data of the target processing group from the change order table 240 (step S1702). From the outlier table 230, the analysis support apparatus 201 extracts the outlier data within the target period of the performance item concerning the resource specified by each record of the extracted change order data (step S1703).

Then, the analysis support apparatus 201 selects a time (collection time) in the target period (step S1704). By referring to the extracted outlier data, the analysis support apparatus 201 determines whether or not an outlier occurs at the selected time (step S1705).

If an outlier occurs (step S1705: Yes), the analysis support apparatus 201 identifies each processing group including the resource of the performance item having the outlier (step S1706). The analysis support apparatus 201 calculates the cloud infrastructure influence degree at the selected time by dividing the number of the identified processing groups by the total number of the processing groups (step S1707), and the proceeds to step S1709.

If an outlier does not occur in step S1705 (step S1705: No), the analysis support apparatus 201 sets the cloud infrastructure influence degree to “0” (step S1708). The analysis support apparatus 201 determines whether or not there is an unselected time (collection time) yet to be selected in the target period (step S1709).

If there is an unselected time (step S1709: Yes), the analysis support apparatus 201 returns to step S1704. On the other hand, if there is no unselected time (step S1709: No), the analysis support apparatus 201 creates the cloud infrastructure influence degree transition graph in which the cloud infrastructure influence degrees at the respective times (collection times) in the target period are presented in time series (step S1710).

The analysis support apparatus 201 outputs the response analysis screen 802 including the created cloud infrastructure influence degree transition graph to the client apparatus 202 (step S1711), and ends the series of processing according to this flowchart.

Accordingly, the analysis support apparatus 201 may cause the client apparatus 202 to display the response analysis screen 802 (for example, see FIGS. 11A to 11D) for determining the influence of the cloud infrastructure on the business system BS.

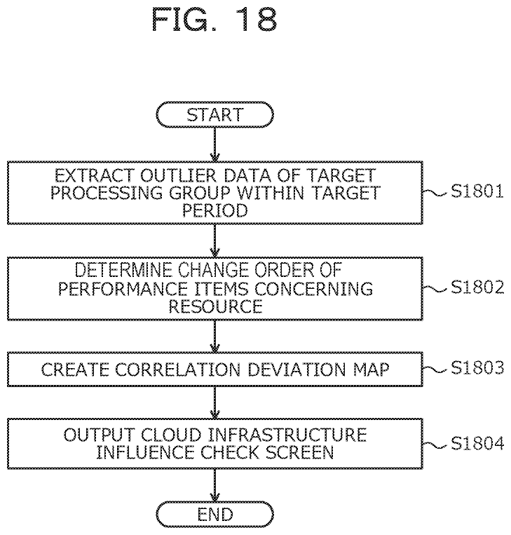

Next, a second output control processing procedure of the analysis support apparatus 201 will be described with reference to FIG. 18. For example, the second output control processing is processing for displaying the cloud infrastructure influence check screen 803 as illustrated in FIGS. 12A and 12B on the client apparatus 202.

FIG. 18 is a flowchart illustrating an example of the second output control processing procedure of the analysis support apparatus 201. In the flowchart in FIG. 18, first, the analysis support apparatus 201 extracts the outlier data of the target processing group within the target period from the outlier table 230 (step S1801).

By referring to the change order table 240, the analysis support apparatus 201 identifies the change order of the performance items concerning the resources used by the processes involved in function_#(step S1802). Next, the analysis support apparatus 201 creates a correlation deviation map based on the extracted outlier data within the target period and the identified change order of the performance items (step S1803).

The correlation deviation map is information in which performance items having outliers at each time when the outliers occur within the target period among the performance items concerning the resources used by the processes involved in function_# are presented in the change order of the performance items such that an order relationship among the performance items is identifiable. For example, in the correlation deviation map, a performance item having an outlier is expressed in a color density corresponding to the magnitude of the deviation degree.

The analysis support apparatus 201 outputs the cloud infrastructure influence check screen 803 including the created correlation deviation map to the client apparatus 202 (step S1804), and ends the series of processing according to this flowchart.

Accordingly, the analysis support apparatus 201 may cause the client apparatus 202 to display the cloud infrastructure influence check screen 803 (for example, see FIGS. 12A and 12B) for determining a performance item affected by the cloud infrastructure.

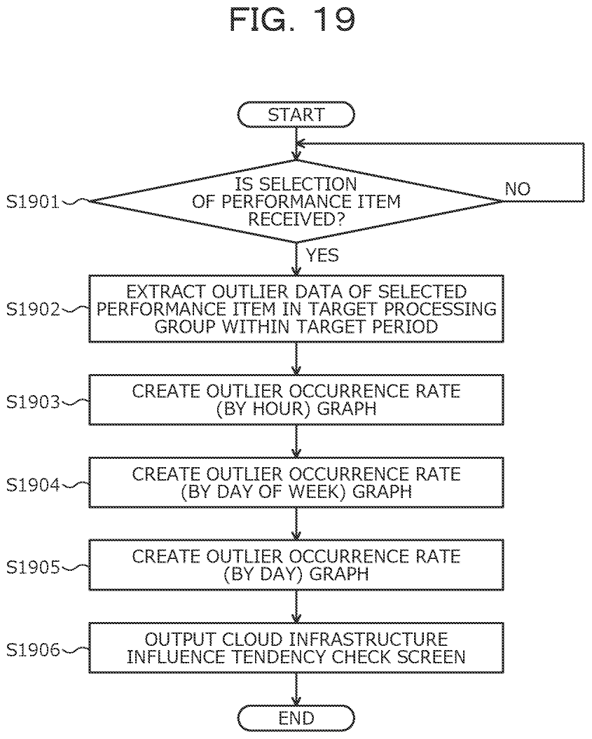

Next, a third output control processing procedure of the analysis support apparatus 201 will be described with reference to FIG. 19. For example, the third output control processing is processing for displaying the cloud infrastructure influence tendency check screen 804 as illustrated in FIG. 13 on the client apparatus 202.

FIG. 19 is a flowchart illustrating an example of the third output control processing procedure of the analysis support apparatus 201. In the flowchart in FIG. 19, first, the analysis support apparatus 201 determines whether or not selection of any of the performance items having the outliers in the target processing group is received (step S1901).

The analysis support apparatus 201 waits for reception of selection of a performance item (step S1901: No). Upon receiving selection of a performance item (step S1901: Yes), the analysis support apparatus 201 extracts the outlier data of the selected performance item in the target processing group within the target period from the outlier table 230 (step S1902).

For the selected performance item, the analysis support apparatus 201 creates an outlier occurrence rate (by hour) graph presenting an outlier occurrence rate by hour in the target period based on the extracted outlier data (step S1903). For the selected performance item, the analysis support apparatus 201 creates an outlier occurrence rate (by day of week) graph presenting an outlier occurrence rate by day of week in the target period based on the extracted outlier data (step S1904).

For the selected performance item, the analysis support apparatus 201 creates an outlier occurrence rate (by day) graph presenting an outlier occurrence rate by day in the target period based on the extracted outlier data (step S1905). The analysis support apparatus 201 outputs the cloud infrastructure influence tendency check screen 804 including the created outlier occurrence rate (by hour) graph, outlier occurrence rate (by day of week) graph, and outlier occurrence rate (by day) graph to the client apparatus 202 (step S1906), and ends the series of processing according to this flowchart.

Accordingly, the analysis support apparatus 201 may cause the client apparatus 202 to display the cloud infrastructure influence tendency check screen 804 (for example, see FIG. 13) for recognizing the frequency or cycle of the influence received from the cloud infrastructure regarding the selected performance item of the target processing group.

As described above, the analysis support apparatus 201 according to the embodiment is able to identify the change order of the resources which are used by the processes involved in function_# in the business system BS and which change in accordance with the execution order of the processes. The analysis support apparatus 201 is able to output, regarding a time t targeted for a performance analysis of the business system, information in which the performance items whose actually measured values at the time t are outliers of the correlations with the response of function_#among the performance items concerning the resources used by the processes involved in function_# are identifiable in accordance with the identified change order.

Accordingly, when a user performs a cause analysis of a response delay of function_# in the business system BS, the analysis support apparatus 201 enables the user to determine the performance items affected by the cloud infrastructure among the performance items concerning the resources used by the processes involved in function_#.

When outputting the information with which the performance items having the outliers are identifiable, the analysis support apparatus 201 is able to output each performance item having an outlier in a manner corresponding to the deviation degree of the actually measured value from the predicted value of the performance item for the response of function_# at the time t.

Accordingly, the analysis support apparatus 201 enables the user to determine how much the performance item having the outlier deviates from the predicted value, and to easily determine which performance item has to be investigated.

Regarding the time t targeted for the performance analysis of the business system BS, the analysis support apparatus 201 is able to calculate, as the cloud infrastructure influence degree, the ratio of the functions that use the resource of the performance item whose actually measured value at the time t is an outlier of the correlation with the response of function_# to the function group of the business system BS. The analysis support apparatus 201 is able to output the calculated cloud infrastructure influence degree in association with the time t.

Accordingly, when the user performs a cause analysis of a response delay of function_# in the business system BS, the analysis support apparatus 201 enables the user to determine an influence of the cloud infrastructure on the business system BS.

When outputting the cloud infrastructure influence degree, the analysis support apparatus 201 is able to further output the actually measured values of the performance items concerning the resources used by the processes involved in function_# at the time t.

Accordingly, the analysis support apparatus 201 enables the user to distinguish whether the response degradation of function_# is due to a problem of the own system or a problem of the cloud infrastructure.

The analysis support apparatus 201 is able to receive selection of any of the performance items having the outliers, and calculate the outlier occurrence rate for the selected performance item by predetermined time range in the target period, based on the outlier data indicating the time points at which the actually measured values of the selected performance item measured in the target period are outliers. The analysis support apparatus 201 is able to output the calculated outlier occurrence rate by predetermined time range.

Thus, the analysis support apparatus 201 enables the user to recognize the frequency or cycle of the influence received from the cloud infrastructure regarding the performance item determined by the user to be affected by the cloud infrastructure. The user may consider what measures to take for the own system, such as, for example, changing a contract in consideration of the frequency or cycle of the influence received from the cloud infrastructure.

The analysis support apparatus 201 is able to calculate an outlier occurrence rate by hour, an outlier occurrence rate by day of week, and an outlier occurrence rate by day in the target period.

The analysis support apparatus 201 enables the user to recognize the tendencies by hour, by day of week, and by day as the tendencies of the influence of the cloud infrastructure on the performance item.

The analysis support apparatus 201 is able to output, for each time (for example, collection time) in the target period, information in which the performance items whose actually measured values at the time are outliers of the correlations with the response of function_#among the performance items concerning the resources used by the processes involved in function_# are identifiable in accordance with the identified change order of the resources.

Accordingly, the analysis support apparatus 201 enables the user to determine the performance item receiving the influence of the cloud infrastructure on the business system BS in time series.

For each time (for example, collection time) in the target period, the analysis support apparatus 201 is able to calculate, as the cloud infrastructure influence degree, the ratio of the functions that use the resource of the performance item whose actually measured value at the time is an outlier of the correlation with the response of function_# to the function group of the business system BS. The analysis support apparatus 201 is able to output information presenting the calculated cloud infrastructure influence degrees at the respective times in time series (for example, the cloud infrastructure influence degree transition graph 1103).

Accordingly, the analysis support apparatus 201 enables the user to determine the influence of the cloud infrastructure on the business system BS in time series.

Based on these effects, when a problem such as a response degradation occurs, the analysis support apparatus 201 and the analysis support system 200 according to the embodiment enables the user to recognize an influence of the cloud infrastructure at an early stage, and improve the convenience of the service.

The analysis support method described in the embodiment may be implemented by a computer such as a personal computer or a workstation executing a program prepared in advance. This analysis support program is recorded in a computer-readable recording medium such as a hard disk, a flexible disk, a CD-ROM, a DVD, or a USB memory, and is read from the recording medium and executed by the computer. Also, the analysis support program may be distributed via a network such as the Internet.

The information processing apparatus 101 (analysis support apparatus 201) described in the embodiment may also be achieved with an integrated circuit (IC) for a specific application, such as a standard cell or a structured application-specific integrated circuit (ASIC), or with a programmable logic device (PLD), such as a field-programmable gate array (FPGA).

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a process, the process comprising:
identifying a change order of resources which are used by processes involved in a first function of a system constructed by using sharable resources and which change in accordance with an execution order of the processes; and
for a specific time targeted for a performance analysis of the system, outputting information with which first performance items among second performance items concerning the resources used by the processes involved in the first function are identifiable in accordance with the identified change order,
wherein each of actually measured values of the first performance items at the specific time is an outlier of a correlation with a response of the first function.

2. The non-transitory computer-readable recording medium according to claim 1, the process further comprising:
outputting each of the first performance items in a manner corresponding to a deviation degree of each of the actually measured values from a corresponding predicted value of each of the first performance items with respect to the response of the first function at the specific time.

3. The non-transitory computer-readable recording medium according to claim 1, the process further comprising:
for the specific time, calculating a ratio of a number of functions that use the resources of the first performance items to a number of functions of the system; and
outputting the calculated ratio in association with the specific time.

4. The non-transitory computer-readable recording medium according to claim 3, the process further comprising:
when outputting the ratio, outputting the actually measured values of the second performance items at the specific time.

5. The non-transitory computer-readable recording medium according to claim 1, the process further comprising:
receiving selection of any one of the first performance items;
for the selected performance item, calculating an outlier occurrence rate by predetermined time range in a period targeted for an analysis of a response delay of the first function, based on data indicating time points at which the actually measured values measured in the period are the outliers; and
outputting the calculated outlier occurrence rate by predetermined time range.

6. The non-transitory computer-readable recording medium according to claim 5, wherein
the predetermined time range is at least one of hour, day of week, and day.

7. The non-transitory computer-readable recording medium according to claim 1, wherein
the first function is a function targeted for an analysis of a response delay.

8. The non-transitory computer-readable recording medium according to claim 1, the process further comprising:
outputting, for each time in a period targeted for an analysis of a response delay of the first function, the information with which the first performance items among the second performance items are identifiable in accordance with the identified change order.

9. The non-transitory computer-readable recording medium according to claim 3, the process further comprising:
calculating the ratio for each time in a period targeted for an analysis of a response delay of the first function; and
outputting information presenting the calculated ratio at each time in time series.

10. The non-transitory computer-readable recording medium according to claim 1, the process further comprising:
outputting the first performance items such that an order relationship between the first performance items is identifiable.

11. An analysis support method, comprising:
identifying, by a computer, a change order of resources which are used by processes involved in a first function of a system constructed by using sharable resources and which change in accordance with an execution order of the processes; and
for a specific time targeted for a performance analysis of the system, outputting information with which first performance items among second performance items concerning the resources used by the processes involved in the first function are identifiable in accordance with the identified change order,
wherein each of actually measured values of the first performance items at the specific time is an outlier of a correlation with a response of the first function.

12. An information processing apparatus, comprising:
a memory; and
a processor coupled to the memory and the processor configured to:
identify a change order of resources which are used by processes involved in a first function of a system constructed by using sharable resources and which change in accordance with an execution order of the processes; and
for a specific time targeted for a performance analysis of the system, output information with which first performance items among second performance items concerning the resources used by the processes involved in the first function are identifiable in accordance with the identified change order,
wherein each of actually measured values of the first performance items at the specific time is an outlier of a correlation with a response of the first function.
